(19) United States
(12) Patent Application Publication
(10) Pub. No.: US 2026/0183698 A1
(43) Pub. Date: Jul. 2, 2026

(54) HANDHELD PORTABLE OXYGEN CONCENTRATOR

(71) Applicant: SICHUAN QIANLI-BEOKA MEDICAL TECHNOLOGY INC., Chengdu (CN)

(72) Inventors: Yuansheng He, Chengdu (CN); Xiaolang Deng, Chengdu (CN); Wen Zhang, Chengdu (CN); Jinghua Li, Chengdu (CN)

(21) Appl. No.: 19/537,477

(22) Filed: Feb. 11, 2026

Related U.S. Application Data
(63) Continuation of application No. PCT/CN2025/144988, filed on Dec. 24, 2025.

(30) Foreign Application Priority Data
Dec. 30, 2024 (CN) 202423272856.2
Sep. 15, 2025 (CN) 202511314379.8
Sep. 15, 2025 (CN) 202511314398.0
Sep. 15, 2025 (CN) 202521980409.4
Sep. 15, 2025 (CN) 202521980417.9
Sep. 15, 2025 (CN) 202521980419.8
Sep. 15, 2025 (CN) 202521980424.9
Sep. 15, 2025 (CN) 202521980434.2
Sep. 15, 2025 (CN) 202521980437.6
Sep. 15, 2025 (CN) 202521980451.6

(51) Int. Cl. B01D 53/047; B01D 53/04

(52) U.S. Cl. CPC B01D 53/0476; B01D 53/0446; B01D 53/0454; B01D 53/047; B01D 2256/12; B01D 2259/4533; B01D 2259/4541

(57) ABSTRACT

A handheld portable oxygen concentrator includes a body of a size suitable for single-handed holding and use, an oxygen generation and storage assembly, an oxygen suction nozzle, and a power supply assembly. The body includes a top face, a bottom face, and a side face. The oxygen generation and storage assembly is arranged in the body and including an air compression assembly, at least one molecular sieve tank, an intake assembly, an oxygen storage assembly, an outlet assembly, and a control board. A projection contour of the at least one molecular sieve tank on a first projection plane is completely or partially overlapped with a projection contour of the air compression assembly on the first projection plane. The oxygen suction nozzle is arranged on the top face of the body and communicated with the outlet assembly. The power supply assembly is arranged on the bottom face of the body.

### CROSS REFERENCE TO RELATED APPLICATIONS

This application is a continuation application of international patent application No. PCT/CN2025/144988, filed on Dec. 24, 2025.

International patent application No. PCT/CN2025/144988 claims priorities of Chinese patent application Nos. 202423272856.2, filed on Dec. 30, 2024, 202511314379.8, filed on Sep. 15, 2025, 202521980424.9, filed on Sep. 15, 2025, 202521980409.4, filed on Sep. 15, 2025, 202521980417.9, filed on Sep. 15, 2025, 202521980434.2, filed on Sep. 15, 2025, 202521980419.8, filed on Sep. 15, 2025, 202511314398.0, filed on Sep. 15, 2025, 202521980437.6, filed on Sep. 15, 2025, and 202521980451.6, filed on Sep. 15, 2025. The disclosure of which is hereby incorporated by reference in their entireties.

### FIELD OF THE DISCLOSURE

The present disclosure relates to the field of oxygen generators, and particularly to a handheld portable oxygen concentrator.

### BACKGROUND

Portable oxygen concentrators have become important equipment for high-altitude travel, outdoor activities, or daily medical needs due to portability and stable endurance. Existing portable oxygen concentrators are generally pulse-type oxygen concentrators. When using oxygen, it is necessary to connect an oxygen outlet of the concentrator to user's nose with a carried nasal cannula. After the oxygen concentrator is turned on, the oxygen concentrator continuously produces and supplies oxygen based on signals fed back from the user's breathing.

However, existing nasal cannulas are generally over 1 meter in length. When worn, the nasal cannulas severely hinder body movement, causing inconvenience in action, and may even lead to personal safety issues. Moreover, due to design shortcomings in a body shape of existing portable oxygen concentrators, it is difficult to directly hold and use the nasal cannulas by hand and move the nasal cannulas to the nostrils for oxygen supply during actual use, i.e., it is difficult to achieve a handheld usage state. In addition, there is also no way to directly contact the oxygen outlet on a portable oxygen concentrator with the user's mouth or nose for oxygen supply. For intermittent oxygen demand scenarios, when an existing oxygen supply method is used, since the nasal cannula needs to be worn before each oxygen inhalation, cumbersome wearing and preparation work is required before each use, making it very troublesome to use, and sometimes even leading to serious personal safety accidents due to untimely oxygen supply. In summary, existing portable oxygen concentrators are difficult to achieve rapid oxygen inhalation.

### SUMMARY

The following presents a simplified summary of the disclosure in order to provide a basic understanding of some aspects of the disclosure. This summary is not an extensive overview of the disclosure. It is not intended to identify critical elements or to delineate the scope of the disclosure. Its sole purpose is to present some concepts of the disclosure in a simplified form as a prelude to the more detailed description that is presented elsewhere.

In some embodiments, a handheld portable oxygen concentrator is provided. The handheld portable oxygen concentrator includes a body of a size suitable for single-handed holding and use, an oxygen generation and storage assembly, an oxygen suction nozzle, and a power supply assembly. The body includes a top face, a bottom face, and a side face. The top face and the bottom face are arranged opposite each other in a height direction of the body, and the side face connects the top face and the bottom face. The oxygen generation and storage assembly is arranged in the body and including an air compression assembly, at least one molecular sieve tank, an intake assembly, an oxygen storage assembly, an outlet assembly, and a control board. The at least one molecular sieve tank is vertically arranged above the air compression assembly. A projection contour of the at least one molecular sieve tank on a first projection plane is completely or partially overlapped with a projection contour of the air compression assembly on the first projection plane. The first projection plane is a plane perpendicular to the height direction of the body. The air compression assembly is configured to deliver compressed air to the at least one molecular sieve tank via the intake assembly. The at least one molecular sieve tank is configured to produce oxygen-enriched gas and deliver the oxygen-enriched gas to the oxygen storage assembly. The oxygen storage assembly is configured to deliver the oxygen-enriched gas outward via the outlet assembly. The oxygen suction nozzle is arranged on the top face of the body, communicated with the outlet assembly, and configured to contact a nose or mouth to guide oxygen. The power supply assembly is arranged on the bottom face of the body, and configured to supply power to the handheld portable oxygen concentrator and serve as a base for the handheld portable oxygen concentrator.

### BRIEF DESCRIPTION OF THE DRAWINGS

Illustrative embodiments of the present disclosure are described in detail below with reference to the attached drawing figures.

FIG. 1 is a first schematic view of an overall structure of a handheld portable oxygen concentrator according to some embodiments of the present disclosure.

FIG. 2 is a second schematic view of the overall structure of the handheld portable oxygen concentrator according to some embodiments of the present disclosure.

FIG. 3 is a first exploded view of the handheld portable oxygen concentrator according to some embodiments of the present disclosure.

FIG. 4 is a second exploded view of the handheld portable oxygen concentrator according to some embodiments of the present disclosure.

FIG. 5 is an exploded view of an oxygen suction nozzle according to some embodiments of the present disclosure.

FIG. 6 is a perspective cross-sectional view of the oxygen suction nozzle according to some embodiments of the present disclosure.

FIG. 7 is a structural view of an outlet assembly according to some embodiments of the present disclosure.

FIG. 8 is a bottom view of the outlet assembly according to some embodiments of the present disclosure.

FIG. 9 is a front view of the outlet assembly according to some embodiments of the present disclosure.

FIG. 10 is a cross-sectional view taken along line A-A in FIG. 9.

FIG. 11 is a cross-sectional view taken along line B-B in FIG. 9.

FIG. 12 is a cross-sectional view taken along line C-C in FIG. 9.

FIG. 13 is a bottom view of a valve bracket according to some embodiments of the present disclosure.

FIG. 14 is a structural view of a air compression assembly and an intake assembly according to some embodiments of the present disclosure.

FIG. 15 is a bottom view of the intake assembly according to some embodiments of the present disclosure.

FIG. 16 is a cross-sectional view taken along line D-D in FIG. 15.

FIG. 17 is a cross-sectional view taken along line E-E in FIG. 15.

FIG. 18 is a schematic diagram showing a relationship between a diameter of a body, a corresponding volume of an oxygen storage tank, and a corresponding blood oxygen concentration when a perimeter of the body ranges from 144 mm to 270 mm according to some embodiments of the present disclosure.

### NUMERAL REFERENCE IN THE DRAWINGS

X1—oxygen generation and storage assembly;
1—body; 10—front housing; 11—rear housing; 12—control board; 120—first electrical connector; 13—sensing unit; 14—top face; 15—bottom face; 16—side face; 17—button;
2—air compression assembly; 20—support frame; 201—base plate; 2010—filter chamber; 2011—air intake grille; 2013—lower pillar; 202—top plate; 2023—upper pillar; 21—air compressing member;
30—molecular sieve tank;
4—oxygen storage assembly; 4a—oxygen storage tank; 40—access port; 42—clearance space; 43—arc-shaped recess; 44—pre-conditioning tank;
5—outlet assembly; 50—upper passage plate; 50a—longitudinal axis; 500—delivery passage; 501—check valve; 502—oxygen inlet passage; 503—oxygen outlet passage; 504—oxygen inlet interface; 505—oxygen outlet interface; 5050—outlet tube; 506—oxygen outlet port; 507—detection air passage; 5070—detection port; 508—communication hole; 51—pulse electromagnetic valve; 52—oxygen outlet electromagnetic valve; 53—equalizing electromagnetic valve; 54—upper positioning rim; 55—valve bracket; 550—connection hole; 551—first side wall; 5511—first passage; 5512—second passage; 552—second side wall; 5523—third passage; 5524—fourth passage; 553—third side wall; 5535—fifth passage; 5536—sixth passage; 554—first corner; 5540—oxygen inlet through hole; 555—second corner; 5550—oxygen outlet through hole; 556—third corner; 5561—first equalizing hole; 5562—second equalizing hole; 56—upper sealing plate; 570—oxygen inlet; 571—gas inlet through hole; 572—gas outlet through hole; 573—first oxygen passage; 574—second oxygen passage; 575—first equalizing passage; 576—second equalizing passage;
6—oxygen suction nozzle; 60—cover body; 600—positioning boss; 601—balance hole; 61—oxygen suction portion; 610—oxygen suction port; 62—oxygen supply tube; 620—main tube; 6200—connection port; 621—branch tube; 6210—tube fastener;
7—power supply assembly; 70—second electrical connector;
80—upper cover; 800—cover body; 801—connection portion; 8010—first rotation shaft; 8011—first spring; 802—locking portion; 81—switch assembly; 810—locking button; 811—second rotation shaft; 812—second spring;
9—intake assembly; 90—lower passage plate; 900—intake passage; 901—connection passage; 902—exhaust passage; 903—air inlet port; 904—exhaust port; 905—air outlet port; 906—air guide hole; 91—first electromagnetic valve; 92—second electromagnetic valve; 921—first valve passage; 922—second valve passage; 923—third valve passage; 93—lower sealing plate;
D—inner diameter of the main tube; d—inner diameter of the branch tube; L—maximum width of the top face or the bottom face; H—distance between the top face and the bottom face.

### DETAILED DESCRIPTION

The following describes some non-limiting exemplary embodiments of the disclosure with reference to the accompanying drawings. The described embodiments are merely a part rather than all of the embodiments of the disclosure. All other embodiments obtained by a person of ordinary skill in the art based on the embodiments of the disclosure shall fall within the scope of the disclosure.

Unless otherwise defined, all technical and scientific terms used herein have the same meaning as commonly understood by those skilled in the art to which the present disclosure belongs. The terms used in the description of the present disclosure herein are intended for describing particular embodiments only and are not intended to limit the present disclosure. In the description, claims, and the above drawings of the present disclosure, the terms “including” and “having”, as well as their variants, are intended to convey a non-exclusive inclusion. The terms “first”, “second”, etc., as used herein, are intended to distinguish between different objects, rather than to describe a particular order.

Reference to “embodiments” herein implies that a particular feature, structure, or characteristic described in conjunction with an embodiment may be included in at least one embodiment of the present disclosure. The appearance of the phrase at various places in the specification does not necessarily refer to the same embodiment, nor is it a separate or an alternative embodiment that is mutually exclusive of other embodiments. One skilled in the art would explicitly and implicitly understand that the embodiments described herein can be combined with other embodiments.

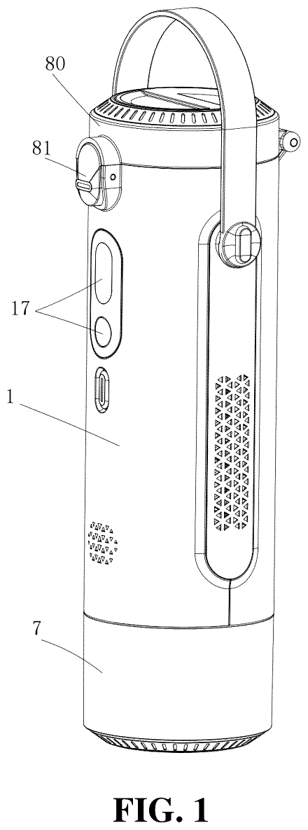

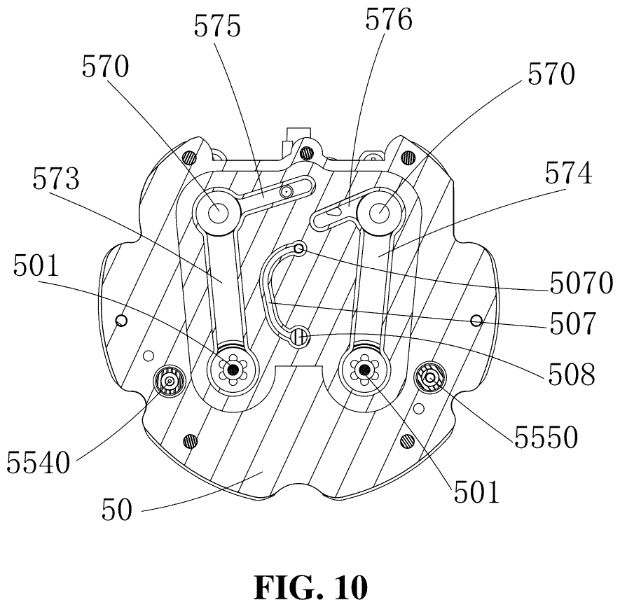

Referring to FIGS. 1-18, the present disclosure provides a handheld portable oxygen concentrator, including a body 1 of a size suitable for single-handed holding and use, an oxygen suction nozzle 6, a power supply assembly 7, and an oxygen generation and storage assembly X1 arranged inside the body 1. The body 1 may include a top face 14, a bottom face 15, and a side face 16 connecting the top face 14 and the bottom face 15. The top face 14 and the bottom face 15 may be arranged opposite each other in a height direction of the body 1 The oxygen generation and storage assembly X1 may include an air compression assembly 2, a molecular sieve tank 30, an intake assembly 9, an oxygen storage assembly 4, an outlet assembly 5, and a control board 12. The molecular sieve tank 30 may be vertically arranged above the air compression assembly 2. A projection contour of the molecular sieve tank 30 on a first projection plane may completely or partially overlap with a projection contour of the air compression assembly 2 on the first projection plane, and the first projection plane may be a plane perpendicular to the height direction of the body 1. The air compression assembly 2 can deliver compressed air to the molecular sieve tank 30 via the intake assembly 9. The molecular sieve tank 30 may produce oxygen-enriched gas and deliver the oxygen-enriched gas to the oxygen storage assembly 4. The oxygen storage assembly 4 can deliver the oxygen-enriched gas outward via the outlet assembly 5. The control board 12 may control an opening and closing of the outlet assembly 5 and an opening and closing of the intake assembly 9. The oxygen suction nozzle 6 may be arranged on the top face 14 of the body 1 and may be communicated with the outlet assembly 5. The oxygen suction nozzle 6 may be used to contact user's nose or mouth to guide oxygen. The power supply assembly 7 may be arranged on the bottom face 15 of the body 1, used to supply power to the handheld portable oxygen concentrator and serve as a base for the handheld portable oxygen concentrator.

Specifically, the body 1 may include a front housing 10 and a rear housing 11, which may be engaged with each other to cooperatively form an internal mounting cavity. This connection manner of the front housing 10 and the rear housing 11 may facilitate a mounting of the oxygen generation and storage assembly X1 and optimize an assembly process of the handheld portable oxygen concentrator. One end of the body 1 in the height direction of the body 1 may form the top face 14, and the other end of the body 1 in the height direction of the body 1 may form the bottom face 15, as well as the side face 16 may connect the top face 14 and the bottom face 15. The top face 14 may be used to mount the oxygen suction nozzle 6, facilitating the user to inhale oxygen through the oxygen suction nozzle 6. The bottom face 15 may be used to mount the power supply assembly 7, allowing the power supply assembly 7 to supply power to internal functional modules while also serving as the base for the entire handheld portable oxygen concentrator. When the handheld portable oxygen concentrator is placed on a plane such as a table, the air compression assembly 2 may be raised away from the table, preventing an air inlet of the air compression assembly 2 from being blocked. The side face 16 may facilitate the user to hold the body 1 for oxygen inhalation. When designing the body 1, to facilitate the user to hold the body 1 with one hand during subsequent use, a plane perpendicular to the height direction of the body 1 may be defined as the first projection plane, i.e., a horizontal plane when the body 1 is placed vertically. At the same time, a perimeter of the projection contour of the body 1 on the first projection plane may be limited to be no greater than 270 mm, i.e., a perimeter of a projection contour of the side face 16 on the first projection plane may be limited to be no greater than 270 mm. When the perimeter of the projection contour of the body 1 is no greater than 270 mm, it can ensure that the body 1 may meet size requirements for finger and palm grip according to ergonomics, i.e., one hand can stably hold the body 1 in a gripping posture. Combined with the body 1 having a structure suitable for single-handed holding and use, the user can achieve single-handed holding of the handheld portable oxygen concentrator. By defining the size of the body 1 of the handheld portable oxygen concentrator that may be held during use, the body 1 may be made suitable for stable single-handed holding and use. The user can pick up the body 1 with one hand and bring the body 1 close to the user's mouth or nose, aligning the oxygen suction nozzle 6 with the user's mouth or nose, to start using oxygen. Throughout a process from needing oxygen to achieving oxygen use, a cumbersome wearing process of traditional nasal cannulas may be omitted, conveniently achieving single-handed rapid oxygen use.

The oxygen generation and storage assembly X1 may include the air compression assembly 2, the molecular sieve tank 30, the intake assembly 9, the oxygen storage assembly 4, the outlet assembly 5, and the control board 12. The air compression assembly 2, located in a bottom area inside the body 1, may be used to generate pressurized gas and introduce the pressurized gas into the molecular sieve tank 30 through the intake assembly 9. The molecular sieve tank 30 may perform oxygen generation processing on the incoming gas and deliver the oxygen-enriched gas to the oxygen storage assembly 4 for temporary storage. The molecular sieve tank 30 may be vertically placed inside the body 1 and located above the air compression assembly 2, which can effectively shorten an air path between the molecular sieve tank 30 and the air compression assembly 2, improving an oxygen generation efficiency of the molecular sieve tank 30. Moreover, the projection contour of the molecular sieve tank 30 on the first projection plane may completely or partially overlap with the projection contour of the air compression assembly 2 on the first projection plane. In this embodiment, the projection contour of the molecular sieve tank 30 on the first projection plane may completely overlap with the projection contour of the air compression assembly 2 on the first projection plane, causing the molecular sieve tank 30 to extend along the height direction of the body 1, the molecular sieve tank 30 and the air compression assembly 2 may adopt a vertically stacked layout, not occupying a lateral space of the body 1, which may be beneficial for minimizing a lateral dimension of the body 1, making the body 1 overall slender and cup-shaped, easy to hold.

To maximize a utilization of an internal space of the body 1, the outlet assembly 5 may also be arranged above the molecular sieve tank 30, with the oxygen storage assembly 4 located between the air compression assembly 2 and the outlet assembly 5. In the height direction of the body 1, the molecular sieve tank 30 and the oxygen storage assembly 4 may be at a same height, and he molecular sieve tank 30 and the oxygen storage assembly 4 may be communicated internally with each other through an internal passage of the outlet assembly 5 above, thereby shortening a gas path between the molecular sieve tank 30 and the oxygen storage assembly 4 and avoiding cross-communication between the molecular sieve tank 30 and the oxygen storage assembly 4 via pipes or tubing. To further shorten a gas path between the molecular sieve tank 30 and the air compression assembly 2, the intake assembly 9 may also be arranged below the molecular sieve tank 30 and mounted above the air compression assembly 2, so that the compressed gas generated by the air compression assembly 2 may directly enter an internal air passage of the intake assembly 9 through an upper outlet of the air compression assembly 2 and may be then introduced into the molecular sieve tank 30 for oxygen generation. In summary, the oxygen generation and storage assembly X1 may adopt a vertical stacked layout inside the body 1, with the air compression assembly 2, intake assembly 9, molecular sieve tank 30, and outlet assembly 5 arranged sequentially from bottom to top along the height direction of the body 1, forming a clear power layer, oxygen generation/storage layer, and outlet layer. This layout may avoid complex crossovers of lines and pipes, maximize utilization of the internal space of the body 1, facilitate assembly, and a stacking manner of the oxygen generation and storage assembly X1 may minimize the lateral dimension of the body 1, and the overall body 1 may be slender and cup-shaped, easy to hold.

The oxygen suction nozzle 6 may be located on the top face 14 outside the body 1. The oxygen suction portion 61 can directly fit against the user's nose or mouth for use, without a need for an additional external oxygen inhalation tube. This may reduce problems such as dangling, entanglement, or inconvenience in wearing associated with soft tubes in traditional oxygen inhalation devices, making an oxygen inhalation process more direct, simplified, and convenient, significantly improving user experience.

The power supply assembly 7 may be located on the bottom face 15 of the body 1, used to provide stable working electrical energy to various components inside the body 1. The power supply assembly 7 may also serve as the base for the handheld portable oxygen concentrator, providing support when placed vertically. Specifically, the power supply assembly 7 may be electrically connected to the control board 12, which may be electrically connected to various components inside the body 1 for power distribution. The control board 12 may also control the opening and closing of the intake assembly 9, completing a regular delivery of compressed are from the air compression assembly 2 into the molecular sieve tank 30 through the intake assembly 9, enabling the molecular sieve tank 30 to perform oxygen generation and nitrogen exhaust according to a predetermined pattern. Furthermore, the control board 12 may control the opening and closing of the outlet assembly 5. The user may trigger a switch integrated on the control board 12 or other sensing trigger switches, causing a gas passage inside the outlet assembly 5 communicating the oxygen storage assembly 4 and the oxygen suction nozzle 6 to open, allowing the oxygen-enriched gas stored in the oxygen storage assembly 4 to be exported to the oxygen suction nozzle 6 via the outlet assembly 5 for the user to inhale oxygen through the oxygen suction nozzle 6.

In summary, in the handheld portable oxygen concentrator, the air compression assembly 2, intake assembly 9, molecular sieve tank 30, outlet assembly 5, and oxygen suction nozzle 6 may be arranged sequentially along the height direction of the body 1, enabling efficient use of the internal space, thereby significantly enhancing compactness of the handheld portable oxygen concentrator. Compared with traditional horizontal arrangements or complex soft tube connection methods, the handheld portable oxygen concentrator of the present disclosure may reduce a connection distance of an internal gas path and structural crossovers, improving oxygen generation efficiency and mounting stability, also reducing an overall volume of the handheld portable oxygen concentrator, and facilitating portability and use. The oxygen suction nozzle 6 arranged on the top face 14 of the body 1 may allow the user to directly fit the oxygen suction nozzle 6 against the nose or mouth for oxygen inhalation without an external oxygen inhalation soft tube, greatly improving the user experience.

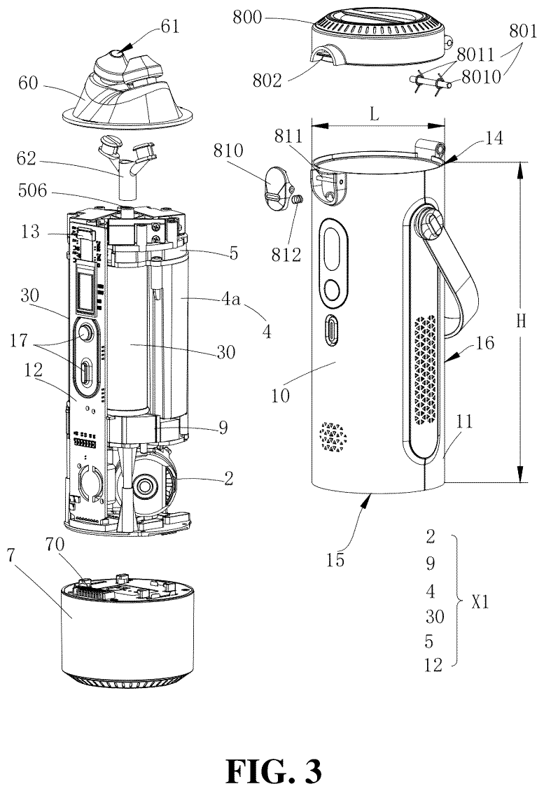

Referring to FIG. 3, in some embodiments, the top face 14 and the bottom face 15 have a maximum width L in a direction perpendicular to the height direction of the body 1. A distance H between the top face 14 and the bottom face 15 may be greater than the maximum width L of the top face 14 or the bottom face 15.

Specifically, by defining that a dimension of the body 1 in the height direction (the distance H between the top face 14 and the bottom face 15) is greater than a maximum lateral width (the maximum width L of the top face 14 or the bottom face 15), an overall shape of the body 1 visually and in terms of holding posture may be closer to a cup/mug shape, i.e., it may have a more pronounced longitudinal extension feature relative to a lateral width of the body 1. When the top face 14 or the bottom face 15 is circular, a width may be a diameter of a circle. This type of shape can provide the user with a holding length that may better conform to palm wrapping and finger gripping, making it easier for the user to find a stable holding position when holding the body 1 with one hand, facilitating the user to hold the body 1 for oxygen inhalation. Particularly, the side face 16 may be arranged with a curved contour that may be easy to hold or arranged with anti-slip members to further enhance stability and comfort of single-handed holding.

Moreover, since the top face 14 may be used to mount the oxygen suction nozzle 6, and the oxygen suction nozzle 6 may be located at an upper end area of the body 1, when the user holds the body 1 with one hand, the cup-like shape of the body 1 may naturally position the top face 14 closer to the user's face. The user may not need to adjust a holding angle additionally to easily align and bring the oxygen suction nozzle 6 close to the user's nose or mouth, making the oxygen inhalation process more convenient and ergonomic. Through the above dimensional relationship, while ensuring the compactness of the body 1, the convenience of single-handed holding of the handheld portable oxygen concentrator and a natural alignment effect of the oxygen suction nozzle 6 may be further improved, enhancing the overall user experience.

In some embodiments, the perimeter of the projection contour of the body 1 on the first projection plane may be not greater than 270 mm. Specifically, when designing the body 1, to facilitate the user to hold the body 1 with one hand during subsequent use, a plane perpendicular to the height direction of the body 1 may be defined as the first projection plane, i.e., the horizontal plane when the body 1 is placed vertically. Moreover, the perimeter of the projection contour of the body 1 on the first projection plane may be limited to be no greater than 270 mm. When the perimeter of the projection contour of the body 1 is no greater than 270 mm, it can ensure that the body 1 may meet the size requirements for finger and palm grip according to ergonomics, i.e., one hand can stably hold the body 1 in a gripping posture. Combined with the body 1 having a structure suitable for single-handed holding and use, the user can achieve single-handed holding of the handheld portable oxygen concentrator.

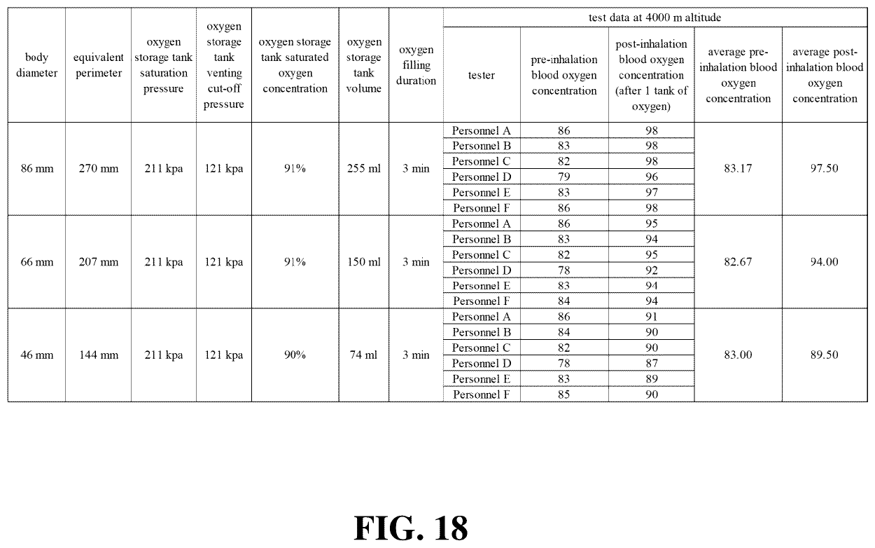

Reducing a size of the body 1 may certainly bring convenience in single-handed holding, but an accompanying defect may be a reduction in the oxygen supply capacity of the oxygen concentrator. When the oxygen supply capacity of the handheld portable oxygen concentrator falls below a certain level, an effect on improving the user's blood oxygen concentration may become insignificant. Therefore, there may be a certain contradiction between the convenience of single-handed holding of the oxygen concentrator and an oxygen supply capacity, requiring trade-offs and balance in design. To achieve a balance between the convenience of single-handed holding and the oxygen supply capacity of the oxygen concentrator, the perimeter of the projection contour of the body 1 on the first projection plane may be limited to a range from 144 mm to 270 mm. Taking the state where the body 1 may be cylindrical as an example, FIG. 18 reflects a relationship among a diameter of the body 1, a corresponding volume of the oxygen storage tank 4a, and a blood oxygen concentration. It can be clearly seen that when the perimeter of the cylindrical body 1 ranges from 144 mm to 270 mm, a good oxygen supply capacity may be achieved. The oxygen-enriched gas stored in the oxygen storage tank 4a may quickly increase the user's blood oxygen concentration, helping the user rapidly improve hypoxia symptoms. After the user finishes inhaling the stored oxygen, the oxygen concentrator may produce oxygen-enriched gas through the molecular sieve tank 30 and store the oxygen-enriched gas in the oxygen storage tank 4a for next use. It can also continuously supply oxygen to help the user maintain blood oxygen concentration. It should be noted here that when the perimeter of the cylindrical body 1 is less than 144 mm, the oxygen concentrator can still achieve oxygen supply function, but due to a decreased oxygen supply capacity, it becomes difficult to quickly increase the blood oxygen concentration. Therefore, limiting the perimeter of the projection contour of the body 1 on the first projection plane to the range of 144 mm- 270 mm can balance the single-handed holding size and the oxygen supply capacity of the oxygen concentrator. Of course, a possibility of further reducing the size of the body 1 at the expense of the oxygen supply capacity of the oxygen concentrator may be not excluded, but it should also fall within the scope of technical solutions easily conceivable in this embodiment.

In some embodiments, to prevent defects such as difficulty finding a good holding angle or unstable holding when the body 1 appears too thick or too elongated in shape, which may be encountered during single-handed holding, combined with ergonomic research, it may be further limited that a distance between two furthest points of the projection contour of the body 1 on the first projection plane may be less than 100 mm, ensuring stability and comfort when the user holds the body 1 with one hand. Particularly, a cross-sectional shape of the body 1 may be one of a circle, ellipse, rectangle, or polygon. When the cross-sectional shape of the body 1 is circular, the distance between the two furthest points of the projection contour of the body 1 on the first projection plane may correspond to a diameter of the cross-sectional shape of the body 1. An outer wall of the body 1 may be optimized, for example, incorporating ergonomics to design some curved faces on the outer wall of the body 1 that may be easy for single-handed holding, or designing anti-slip protrusions and other structures that adapt to fingers and palms and prevent the body 1 from slipping during single-handed holding, thereby enabling the body 1 to have a structure suitable for single-handed holding and use, improving the stability and comfort of single-handed holding.

Referring to FIGS. 3, 4, and 7-13, in some embodiments, the outlet assembly 5 may include an upper passage plate 50, a delivery passage 500, and an oxygen outlet passage 503. The delivery passage 500 and the oxygen outlet passage 503 may be formed inside the upper passage plate 50. The upper passage plate 50 may be of a plate-like structure. The delivery passage 500 and the oxygen outlet passage 503 may be isolated from each other inside the upper passage plate 50. The delivery passage 500 may communicate the molecular sieve tank 30 and the oxygen storage assembly 4. The oxygen outlet passage 503 may communicate the oxygen storage assembly 4 and the oxygen suction nozzle 6.

Specifically, the upper passage plate 50 may be of the plate-like structure, with internal passages formed for delivering oxygen, including the delivery passage 500 and the oxygen outlet passage 503. The two of the delivery passage 500 and the oxygen outlet passage 503 may be isolated from each other to avoid mutual interference between different gas flow paths. Check valves may also be respectively arranged in the delivery passage 500 and the oxygen outlet passage 503 to control the opening and closing of the delivery passage 500 and the oxygen outlet passage 503 respectively. The plate-like structure can allow the upper passage plate 50 to serve as a common upper support for both the molecular sieve tank 30 and the oxygen storage assembly 4, while also serving as an integrated air passage base for realizing vertical delivery of oxygen from the oxygen generation area to the oxygen storage area and then to the oxygen suction nozzle 6. For example, an oxygen outlet port 506 communicated with the oxygen outlet passage 503 may be formed on the upper passage plate 50. The oxygen outlet port 506 may be communicated with the oxygen suction nozzle 6. Since the gas passages are directly integrated inside a plate body of the upper passage plate 50, compared to a traditional air passage form including multiple sections of soft tubes, the upper passage plate 50 can reduce the number of internal soft tubes and complexity of routing, further reducing a space occupation inside the body 1 and making an overall arrangement of the body 1 more regular. The plate-like structure may also facilitate forming a stable contact interface with each of the oxygen storage assembly 4 and the molecular sieve tank 30, benefiting overall sealing performance and structural stability. Meanwhile, a planar feature of the plate-like structure can make the upper passage plate 50 easy to achieve layered arrangement with other components inside the body 1 in the height direction of the body 1, thereby improving a layout compactness of an entire machine of the handheld portable oxygen concentrator. The outlet assembly 5 may adopt the upper passage plate 50 integrating the delivery passage 500 and the oxygen outlet passage 503, replacing traditional soft tube connections, making the gas passages shorter and more stable. The upper passage plate 50 may serve as a core air passage base, simplifying assembly and improving sealing.

Referring to FIGS. 3, 4, and 14, in some embodiments, the air compression assembly 2 may include a support frame 20 and an air compressing member 21 arranged in the support frame 20. The intake assembly 9 may be arranged on a top portion of the support frame 20. The molecular sieve tank 30 and the oxygen storage assembly 4 may be arranged adjacent to each other, and both the molecular sieve tank 30 and the oxygen storage assembly 4 may be arranged between the support frame 20 and the upper passage plate 50. A bottom portion of the molecular sieve tank 30 may be connected to and communicated with the intake assembly 9. A top portion of the molecular sieve tank 30 may be connected to the upper passage plate 50 and communicated with one end of the delivery passage 500. A bottom portion of the oxygen storage assembly 4 may be connected to the support frame 20. A top portion of the oxygen storage assembly 4 may be connected to the upper passage plate 50 and communicated with the other end of the delivery passage 500.

Specifically, the support frame 20 may be arranged inside the body 1 close to the bottom face 15, serving as a carrying foundation for the air compressing member 21, the intake assembly 9, the molecular sieve tank 30, and the oxygen storage assembly 4. The air compressing member 21 may be mounted inside the support frame 20. The intake assembly 9 may be located on a top portion of the support frame 20 and communicated with the air compressing member 21. The intake assembly 9 may directly abut against the bottom portion of the molecular sieve tank 30 and communicated with the molecular sieve tank 30, allowing the compressed air to be directly introduced into the molecular sieve tank 30 along the height direction. The molecular sieve tank 30 and the oxygen storage assembly 4 may be both arranged in a space between the support frame 20 and the upper passage plate 50 and may be arranged adjacent to each other along the height direction, allowing the molecular sieve tank 30 and the oxygen storage assembly 4 to form a compact arrangement using a middle area inside the body 1. Since the top portion of the molecular sieve tank 30 is connected with the upper passage plate 50, and the oxygen storage assembly 4 is also connected to the upper passage plate 50 through the top portion of the oxygen storage assembly 4, the gas paths from the molecular sieve tank 30 to the oxygen storage assembly 4 and then to the oxygen suction nozzle 6 may be all formed inside the upper passage plate 50, without a need for additional bent soft tubes or long-distance connectors. An internal structure of the upper passage plate 50 may significantly shorten an airflow path, reducing a space occupied by cross-layer air passages and soft tube entanglement in traditional devices, and achieving overall miniaturization while maintaining smooth oxygen generation paths. The oxygen storage assembly 4 may be located in the middle area of the body 1, facilitating full utilization of internal space of the oxygen concentrator. A volume of the oxygen storage assembly 4 may be expanded as needed, allowing more oxygen to be stored and improving output stability. Furthermore, the molecular sieve tank 30 and the oxygen storage assembly 4 may be arranged adjacent to each other. Within an allowable width of the body 1, multiple molecular sieve tanks 30 may be arranged, allowing higher oxygen generation efficiency to be maintained while reducing an overall volume of the oxygen concentrator.

Referring to FIGS. 3, 4, 7, 8, and 9, in some embodiments, the handheld portable oxygen concentrator may further include a pre-conditioning tank 44. The pre-conditioning tank 44 may communicate the molecular sieve tank 30 and the oxygen storage assembly 4. The oxygen-enriched gas produced by the molecular sieve tank 30 may be delivered into the oxygen storage assembly 4 through the pre-conditioning tank 44. Specifically, the pre-conditioning tank 44 may serve as a pressure buffer chamber, enabling the oxygen-enriched gas produced by the molecular sieve tank 30 to have sufficient pressure to enter the oxygen storage assembly 4. The pre-conditioning tank 44 may also balance a gas pressure inside the molecular sieve tank 30 and the oxygen storage assembly 4 respectively, preventing the molecular sieve tank 30 from experiencing a pressure drop due to exporting oxygen-enriched gas. This may ensure that an internal pressure of the molecular sieve tank 30 can remain unchanged while exporting oxygen-enriched gas, allowing continuous oxygen production and improving oxygen generation efficiency.

In some embodiments, the oxygen storage assembly 4 may include an oxygen storage tank 4a for storing oxygen-enriched gas. The pre-conditioning tank 44 may be located inside the oxygen storage tank 4a. A top portion of the pre-conditioning tank 44 may be connected to the upper passage plate 50 and communicated with the delivery passage 500. The molecular sieve tank 30 may be communicated with the oxygen storage tank 4a through the pre-conditioning tank 44.

Specifically, the pre-conditioning tank 44 may be arranged inside the oxygen storage tank 4a, with the top portion of the pre-conditioning tank 44 connected to the upper passage plate 50 to be communicated with the delivery passage 500, allowing the oxygen-enriched gas discharged from the molecular sieve tank 30 to enter the oxygen storage tank 4a via the pre-conditioning tank 44. The pre-conditioning tank 44 may serve as an gas buffer chamber, providing pressure equalization and stabilization for the oxygen-enriched gas with pressure fluctuations during the oxygen generation cycle, maintaining the oxygen pressure inside the oxygen storage tank 4a in a more stable range, thereby facilitating continuous and stable oxygen supply at the oxygen suction nozzle 6 end. Arranging the pre-conditioning tank 44 inside the oxygen storage tank 4a can prevent the pre-conditioning tank 44 from occupying lateral space of the body 1, avoiding an increase in an overall width or cross-sectional area due to adding an auxiliary chamber, which may be beneficial for maintaining a compact overall structure. Moreover, an internal arrangement of the pre-conditioning tank 44 in the oxygen storage tank 4a may also make a communication between the pre-conditioning tank 44 and the oxygen storage tank 4a more direct, reducing the number of connectors and improving air passage compactness. In other embodiments, to adapt to different layout requirements or different structural may form of the oxygen storage tank 4a, the pre-conditioning tank 44 may also be arranged outside the oxygen storage tank 4a, communicating with the delivery passage 500 and the oxygen storage tank 4a via tubing, to meet design requirements of different oxygen concentrators. In other embodiments, the oxygen storage assembly 4 may also be an oxygen storage pipeline, an oxygen storage chamber integrally formed on an inner wall of the body 1, or an oxygen storage chamber integrally formed on a bottom face of the upper passage plate 50. The present disclosure does not uniquely limit the form of the oxygen storage assembly 4.

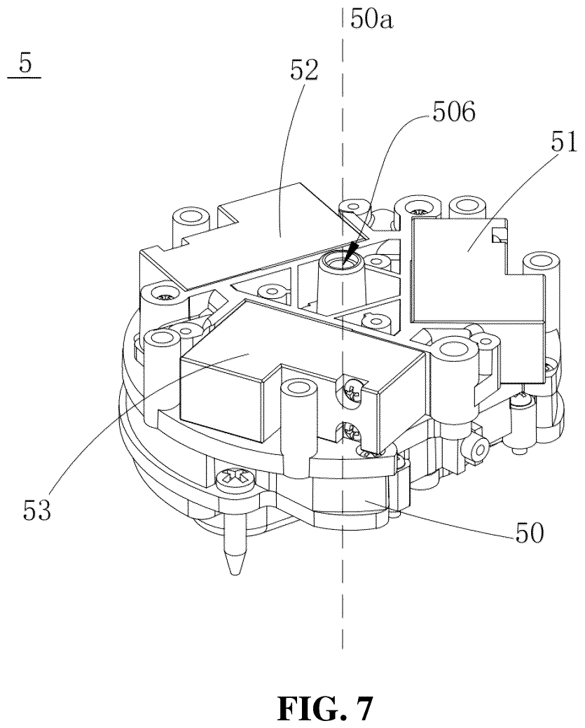

Referring to FIGS. 7-13, in some embodiments, the outlet assembly 5 may further include a pulse electromagnetic valve 51, an oxygen outlet electromagnetic valve 52, and an equalizing electromagnetic valve 53. Each of the pulse electromagnetic valve 51, oxygen outlet electromagnetic valve 52, and equalizing electromagnetic valve 53 may be arranged on the upper passage plate 50. Each of the pulse electromagnetic valve 51, oxygen outlet electromagnetic valve 52, and equalizing electromagnetic valve 53 may be arranged on a side of the upper passage plate 50 away from the molecular sieve tank 30. The pulse electromagnetic valve 51 may be communicated with the delivery passage 500 and may deliver the oxygen-enriched gas produced by the molecular sieve tank 30 to the oxygen storage assembly 4. The oxygen outlet electromagnetic valve 52 may be communicated with the oxygen outlet passage 503 and may export the oxygen-enriched gas stored in the oxygen storage assembly 4 to the oxygen suction nozzle 6. A plurality of molecular sieve tanks 30 may be provided. The equalizing electromagnetic valve 53 may be communicated with the plurality of molecular sieve tanks 30.

Specifically, taking the oxygen storage assembly 4 being the oxygen storage tank 4a as an example for explanation; the pulse electromagnetic valve 51, oxygen outlet electromagnetic valve 52, and equalizing electromagnetic valve 53 may respectively correspond to different control needs during oxygen generation, oxygen supply, and nitrogen exhaust processes. The pulse electromagnetic valve 51 may control a rhythm of oxygen entering the oxygen storage tank 4a from the molecular sieve tank 30, making the oxygen generation cycle run more smoothly. The oxygen outlet electromagnetic valve 52 may regulate a timing and flow of oxygen output from the oxygen storage tank 4a to the oxygen suction nozzle 6. For arrangement with multiple molecular sieve tanks 30, the equalizing electromagnetic valve 53 may communicate air passages of different molecular sieve tanks 30 to achieve nitrogen exhaust and pressure equalization during operation. All three electromagnetic valves including the pulse electromagnetic valve 51, oxygen outlet electromagnetic valve 52, and equalizing electromagnetic valve 53 may be arranged on the side of the upper passage plate 50 away from the molecular sieve tank 30, i.e., on a top portion of the upper passage plate 50, so that the three electromagnetic valves may not occupy a vertical mounting space between a bottom side of the upper passage plate 50 and the support frame 20. Since a vertical mounting space is used to mount the molecular sieve tank 30 and the oxygen storage tank 4a, moving the electromagnetic valves to the top portion of the upper passage plate 50 may effectively free up a core functional area inside the body 1, allowing the molecular sieve tank 30 to increase in number as needed, and the oxygen storage tank 4a may also be arranged with a larger capacity to improve an overall oxygen generation performance and oxygen storage capacity in a limited volume. Furthermore, the electromagnetic valves may be directly mounted on the upper passage plate 50 and communicated with the delivery passage 500 or oxygen outlet passage 503, making the gas passages more centralized and compact, reducing an arrangement of additional soft tubes or adapters, further reducing air passage losses, and improving internal space utilization.

As shown in FIG. 7, the upper passage plate 50 may have a longitudinal axis 50a extending along a thickness direction of the upper passage plate 50 and passing through a center of the upper passage plate 50. The pulse electromagnetic valve 51, oxygen outlet electromagnetic valve 52, and equalizing electromagnetic valve 53 may be spaced apart from each other and arranged about the longitudinal axis 50a. Specifically, the pulse electromagnetic valve 51, oxygen outlet electromagnetic valve 52, and equalizing electromagnetic valve 53 may be arranged in an equilateral triangle on the upper passage plate 50, which may be suitable for bodies 1 with circular or triangular cross-sections, making an overall structural arrangement compact and fully utilizing a thickness space of the upper passage plate 50 to integrate gas passages internally, realizing an air passage arrangement for oxygen inlet, oxygen outlet of the oxygen storage tank 4a, and pressure equalization of the molecular sieve tank 30. Additionally, arranging the three electromagnetic valves together may also facilitate wiring, avoiding messy wiring problems, improving convenience for maintenance and repair, and forming a unit module after integrating the three electromagnetic valves for integrated overall assembly.

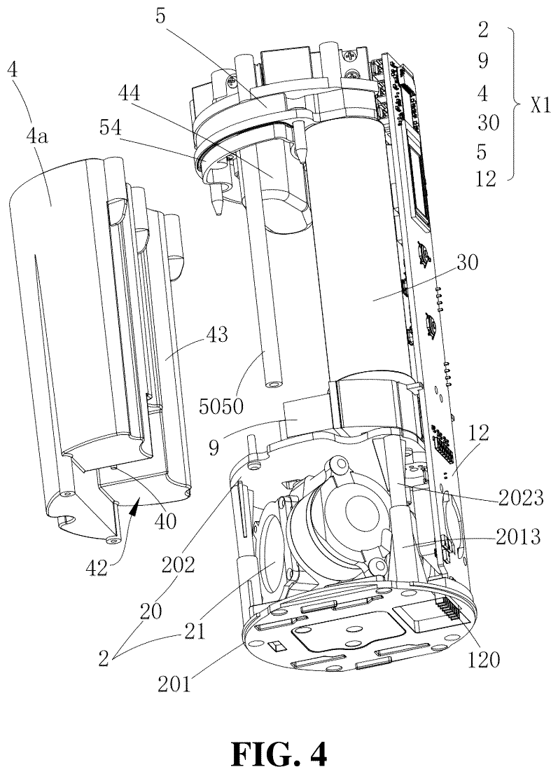

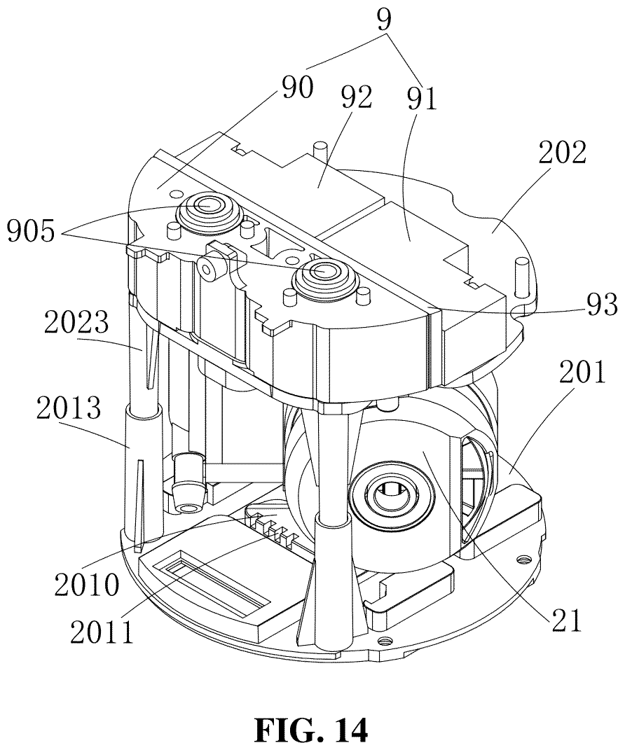

Referring to FIGS. 4 and 14, in some embodiments, the air compression assembly 2 may include a support frame 20 and an air compressing member 21 arranged within the support frame 20. The support frame 20 may be mounted in the body 1, and the bottom portion of the support frame 20 may serve as the bottom face 15 of the body 1. The handheld portable oxygen concentrator may further include a control board 12 arranged in the body 1. The control board 12 may be vertically arranged along the height direction of the body 1. One end of the control board 12 may be close to the oxygen suction portion 61, and the other end of the control board 12 may be arranged with a first electrical connector 120 and connected to the bottom portion of the support frame 20, with the first electrical connector 120 at least partially exposed outside the body 1. The power supply assembly 7 may be detachably mounted on the bottom portion of the support frame 20 and may be arranged with a second electrical connector 70 connectable to the first electrical connector 120.

Specifically, an overall structure of the body 1 may be a tubular structure with open ends at both a front end and a back end of the body 1, allowing the internal space of the body 1 to penetrate longitudinally through the body 1, facilitating vertical stacked mounting of various functional modules. The support frame 20 may be fixedly mounted at the bottom portion inside the body 1, and a bottom face of the support frame 20 may directly constitute a bottom boundary of the body 1, giving the body 1 a stable bottom closure structure while maintaining a tubular shape. Overall, the support frame 20 may be of a hollow structure and may internally accommodate the air compressing member 21, such as a miniature air compressing member 21, allowing the air compressing member 21 to be centrally mounted in the bottom area of the body 1, which may help lower a device's center of gravity and improve layout compactness. The control board 12 may be vertically arranged along the height direction of the body 1 and arranged close to the inner wall of the body 1. The upper end of the control board 12 may extend close to the oxygen suction portion 61. The lower end of the control board 12 may be arranged with the first electrical connector 120 and connected to the bottom portion of the support frame 20, allowing the control board 12 to serve as the electrical control center of an entire machine, electrically or pneumatically connected (a plurality of pneumatic sensors may be arranged on the control board 12) to functional modules such as the air compression assembly 2, molecular sieve tank 30, oxygen storage tank 4a, and electromagnetic valves. The first electrical connector 120 may be partially exposed from a bottom area of the body 1 for quick connection with the power supply assembly 7. The power supply assembly 7 may be detachably mounted on the bottom portion of the support frame 20 and may be connected to the first electrical connector 120 via the second electrical connector 70, supplying power to the entire device. A detachable arrangement may allow the user to directly remove the power supply assembly 7 for charging or battery pack replacement without opening a housing of the body 1, improving convenience of use. In other embodiments, the power supply assembly 7 may also adopt a non-detachable built-in arrangement and supply power to the device through a charging port to meet different form factor requirements.

Referring to FIGS. 1-6, in some embodiments, the oxygen suction nozzle 6 may include a cover body 60, an oxygen suction portion 61 arranged on the cover body 60, and an oxygen supply tube 62 arranged on the cover body 60. The cover body 60 may be arranged on the top face 14 of the body 1. The oxygen supply tube 62 may be arranged inside the cover body 60 and may communicate the oxygen suction portion 61 and the outlet assembly 5. The oxygen suction portion 61 may be used to contact the nose or mouth to guide oxygen.

Specifically, the cover body 60 may cover the top face 14 of the body 1. The oxygen supply tube 62 may be arranged inside the cover body 60. The oxygen supply tube 62 may be a hollow oxygen delivery pipe. One end of the oxygen supply tube 62 may be communicated to the oxygen suction portion 61, and the other end of the oxygen supply tube 62 may be communicated to the outlet assembly 5, thereby delivering oxygen originating from the oxygen storage tank 4a to the oxygen suction portion 61 via the outlet assembly 5 and guiding oxygen to the user's mouth or nose through the oxygen suction portion 61. The oxygen suction portion 61 may be specifically arranged at a top portion of the cover body 60. During actual use, the oxygen suction portion 61 at the top portion of the cover body 60 may be directed towards the user's nose or mouth for contact to achieve oxygen guidance. When not in use, the oxygen suction portion 61 may be directly separated from the user's nose or mouth. Integrated to the handheld portable oxygen concentrator, the oxygen suction nozzle 6 may be enabled to move to a target area of the user in a single-handed holding state, achieving a use-as-you-take usage form.

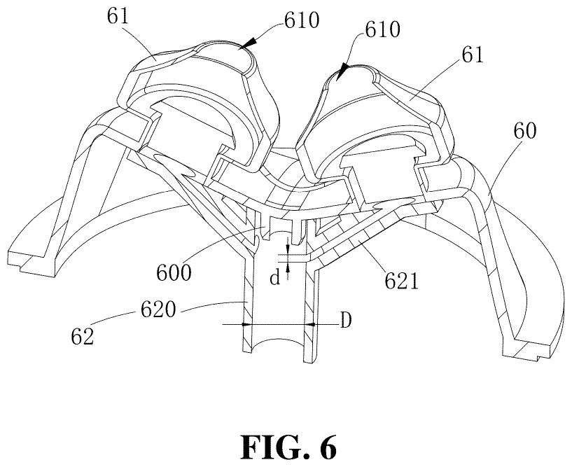

Referring to FIG. 6, in some embodiments, two oxygen suction portions 61 may be provided. The oxygen supply tube 62 may include a main tube 620 for communicating to the outlet assembly 5, and at least two branch tubes 62 respectively extending to the two oxygen suction portions 61. An inner diameter D of the main tube 620 may be greater than an inner diameter d of each of the branch tubes 62.

Specifically, the main tube 620 may be communicated to the outlet assembly 5. The number of the branch tubes 621 may be two, and two branch tubes 621 may be symmetrically arranged on both sides of the main tube 620 along an axial direction of the main tube 620. An axis of each of the branch tubes 62 may be obliquely intersected with an axis of the main tube 620. Ultimately, the main tube 620 and the branch tubes 621 may cooperatively form a Y-shaped structure. During actual oxygen use, oxygen may enter the main tube 620 from the oxygen storage tank 4a through the outlet assembly 5, and may be then evenly distributed to the branch tubes 62 on the left and right sides of the main tube 620. As shown in FIG. 6, the inner diameter D of the main tube 620 may be greater than the inner diameter d of each of the branch tubes 62, causing a pressure of the oxygen to increase when the oxygen enters the branch tubes 62 from the main tube 620, thereby increasing a flow velocity of the oxygen ejected from outlet ports at ends of the branch tubes 62. This can allow the user to inhale more oxygen in a short time, quickly increasing the user's blood oxygen concentration level. Particularly, to ensure the oxygen flow velocity at the outlet ports of the branch tubes 62, a ratio of the inner diameter D of the main tube 620 to the inner diameter d of each of the branch tubes 62 may be set to be greater than 2. As shown in FIG. 6, a top portion of the cover body 60 may be arranged with a pair of oxygen suction portions 61, each oxygen suction portion 61 may be arranged with an oxygen suction port 610. An external contour shape of the oxygen suction portion 61 may be adapted to a shape of a nostril, facilitating contact of the oxygen suction portion 61 with the nostril during use. In this embodiment, the external contour of each oxygen suction portion 61 may be shaped as a gradually converging trumpet, and the oxygen suction port 610 may be arranged at an outlet of a respective trumpet. The cover body 60 may define a balance hole 601 communicating an interior of the cover body 60 with an outside of the cover body 60, allowing an air exhaled by the user to be promptly expelled. Moreover, a direction of the oxygen suction port 610 may be also consistent with a direction of the outlet ports of the branch tubes 62, ensuring that a direction of oxygen ejected from the outlet ports of the branch tubes 62 may be towards the user's mouth or nose. The oxygen suction portions 61 may be fixed on a base of the cover body 60. The base of the cover body 60 may be cover-shaped and may form an inner cavity. The base of the cover body 60 may enclose the main tube 620 and the branch tubes 62 within the inner cavity of the cover body 60.

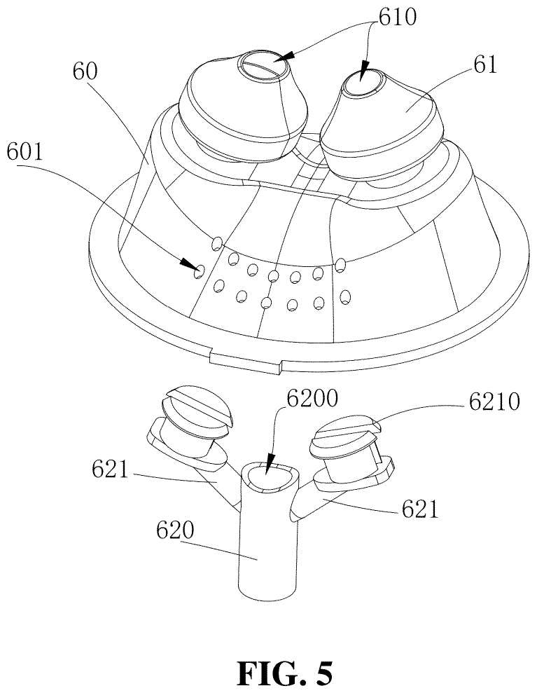

Referring to FIGS. 5 and 6, to facilitate mounting the oxygen supply tube 62 on the cover body 60, the top portion of the main tube 620 may define a connection port 6200. An inner wall of the cover body 60 may be arranged with a positioning boss 600. The positioning boss 600 may be centrally arranged inside the cover body 60, protruding downward from an inner wall face of the cover body 60. When the positioning boss 600 is engaged into the connection port 6200 at the top portion of the main tube 620, positioning between the cover body 60 and the main tube 620 may be achieved. At the same time, the positioning boss 600 can also seal the connection port 6200 at the top portion of the main tube 620, allowing all oxygen in the main tube 620 to be output via the branch tubes 62 communicated with the main tube 620. As shown in FIGS. 5 and 6, each branch tube 62 may be arranged with a tube fastener 6210 at an outer edge of the outlet port of the respective branch tube 62. The tube fastener 6210 may protrude in a direction perpendicular to the axis of the respective branch tube 62 and may be arranged to surround an outer periphery of the outlet port of the respective branch tube 62. The tube fastener 6210 may be engaged in an engagement groove on the inner wall of the oxygen suction portion 61 in a snap-fitted manner. The tube fastener 6210 may be snap-fitted into the engagement groove, aligning an axis of the oxygen suction port 610 with an axis of the outlet port of a respective branch tube 62. This design may ensure during actual use that the oxygen ejected from the outlet port of each branch tube 62 can pass unobstructed in a straight line through the oxygen suction port 610 and continue in a straight line directly into the user's mouth or nose. Furthermore, when the user chooses not to insert the oxygen suction port 610 into the mouth or nose, because a direction of the outlet port of the branch tube 62 may be consistent with an outlet direction of the respective oxygen suction port 610, the user can also aim the oxygen suction port 610 at their nose or mouth, keeping the oxygen suction port 610 close to but not directly contacting their nose or mouth, allowing the oxygen suction port 610 to spray oxygen towards their nose or mouth. This situation may be particularly suitable for scenarios where the handheld portable oxygen concentrator is used in a spray oxygen mode, improving convenience of oxygen use. Due to a high velocity of the sprayed oxygen, a sufficient oxygen supply may also be obtained. The cover body 60 may be made of a flexible material, such as silicone or fluorosilicone rubber. Similarly, the main tube 620 and branch tubes 62 may also be made of flexible materials like silicone or fluorosilicone rubber. The flexible material may allow the cover body 60 and the oxygen suction portion 61 to deform when contacting the nose or mouth or during storage, facilitating storage.

In other embodiments, the oxygen suction nozzle 6 may be any one of a nasal cannula, a breathing mask, a mouthpiece oxygen suction head, a nasal mask oxygen suction head, and a jet-type oxygen supply interface. The oxygen suction nozzle 6 may adopt various structures such as the nasal cannula, breathing mask, mouthpiece oxygen suction head, nasal mask oxygen suction head, jet-type oxygen supply interface, or a combination thereof according to needs.

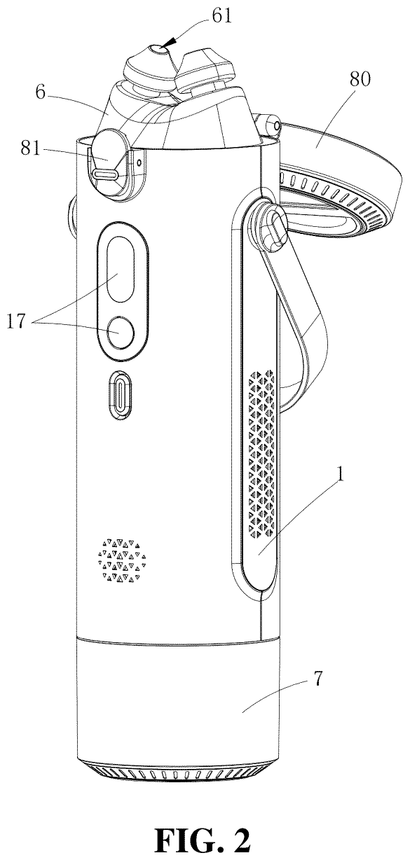

Referring to FIGS. 2 and 3, in some embodiments, the control board 12 may be integrated with a button 17. At least a portion of the button 17 may be exposed on the side face 16 of the body 1. When the button 17 is triggered, the oxygen-enriched gas in the oxygen storage assembly 4 may flow to the oxygen suction nozzle 6 through the outlet assembly 5. Specifically, a through-hole for exposing the button 17 may be formed on the side face 16 of the body 1, allowing the user to directly touch and press the button 17 while holding the side face 16 of the body 1. Through the control board 12, the gas passage inside the outlet assembly 5 may be opened or closed, allowing the user to press the button 17 when oxygen is needed to export the oxygen-enriched gas stored in the oxygen storage assembly 4 to the oxygen suction nozzle 6 for the user to inhale oxygen. When oxygen use is finished or not needed, pressing the button 17 again may close the gas passage inside the outlet assembly 5 communicating the oxygen storage assembly 4 and the oxygen suction nozzle 6, stopping oxygen supply from the oxygen storage assembly 4. The button 17 may be further arranged on a portion of the side face 16 close to the top face 14, so that when the user holds the body 1 with one hand, the user's thumb can naturally contact the button 17, facilitating the user to control the oxygen supply of the handheld portable oxygen concentrator via the button 17, improving the user experience. The button 17 may also be arranged with an oxygen supply switch and an oxygen generation switch which may be separately operable, allowing the user to customize control of oxygen generation and oxygen supply of the handheld portable oxygen concentrator.

Referring to FIGS. 1, 2, and 3, in some embodiments, the handheld portable oxygen concentrator may further include an upper cover 80 connected to the top face 14 of the body 1. The oxygen suction nozzle 6 may be located within a cavity cooperatively formed by the upper cover 80 and the top face 14. When the upper cover 80 is opened, the oxygen-enriched gas in the oxygen storage assembly 4 can flow to the oxygen suction nozzle 6 through the outlet assembly 5.

Specifically, the handheld portable oxygen concentrator may further include a switch assembly 81 arranged on the body 1. The upper cover 80 may be arranged on the top face 14 of the body 1, and the upper cover 80 and the top face 14 of the body 1 may cooperatively define a cavity for accommodating the oxygen suction nozzle 6. The upper cover 80 may include a cover body 800, a connection portion 801 arranged on the cover body 800, and a locking portion 802 arranged on the cover body 800. The connection portion 801 may be rotatably connected to the body 1. The locking portion 802 may cooperate with the switch assembly 81, allowing the upper cover 80 to switch between an open state and a closed state relative to the body 1.

The upper cover 80 and the top face 14 of the body 1 may cooperatively form an openable/closable structure, specifically, a flip-open type, a press-on cover, or a threaded connection. As shown in FIGS. 2 and 3, the upper cover 80 may be rotatably connected to a junction between the top face 14 and the side face 16 of the body 1 through the connection portion 801, realizing a flip-open connection. The connection portion 801 may include a first rotation shaft 8010 and a first spring 8011 sleeved on the first rotation shaft 8010. The upper cover 80 may rotate about the first rotation shaft 8010 to open or close. Since the first spring 8011 is sleeved on the first rotation shaft 8010, under an action of the first spring 8011, the upper cover 80 may remain in an open state until the upper cover 80 is pressed or fixed by an external force to maintain a closed, fastened state. Correspondingly, the switch assembly 81 may be arranged on the side face 16 of the body 1 close to the top face 14, used to connect with the locking portion 802. The switch assembly 81 may include a locking button 810. The locking button 810 may be rotatably connected to a top portion of the side wall of the body 1 via a second rotation shaft 811. The second rotation shaft 811 may be arranged horizontally. The second rotation shaft 811 may be rotatably arranged at a middle portion of the locking button 810. The locking button 810 can move like a seesaw with the second rotation shaft 811 as a pivot. A second spring 812 may be sleeved on the second rotation shaft 811. Under an action of the second spring 812, a portion of the locking button 810 above the second rotation shaft 811 may be closer to the body 1 than a portion of the locking button 810 below the second rotation shaft 811. When the user presses the portion of the locking button 810 below the second rotation shaft 811, utilizing the aforementioned seesaw effect, the portion of the locking button 810 below the second rotation shaft 811 may move closer to the body 1, while the portion of the locking button 810 above the second rotation shaft 811 may move away from the body 1. Thus, when the portion of the locking button 810 above the second rotation shaft 811 is closer to the body 1, i.e., when the portion of the locking button 810 above the second rotation shaft 811 is engaged and fixed with the locking portion 802 of the upper cover 80, the upper cover 80 may be in a closed state. The locking portion 802 of the upper cover 80 may specifically be a groove. Pressing the portion of the locking button 810 below the second rotation shaft 811 may drive the portion of the locking button 810 above the second rotation shaft 811 away from the upper cover 80. The upper cover 80, no longer fixed by the locking button 810, can automatically open under the action of the first spring 8011 of the connection portion 801, and the oxygen suction nozzle 6 may be immediately exposed to the user.

Referring to FIG. 3, the handheld portable oxygen concentrator may further include a sensing unit 13 electrically connected to the control board 12. The sensing unit 13 may detect and acquire a signal indicating the upper cover 80 being opened from the body 1 or a signal indicating the upper cover 80 being closed on the body 1. When the sensing unit 13 detects the signal indicating the upper cover 80 being opened from the body 1, the oxygen-enriched gas in the oxygen storage assembly 4 may flow to the oxygen suction nozzle 6 through the outlet assembly 5, i.e., the sensing unit 13 can control to open the oxygen outlet passage 503 inside the outlet assembly 5 via the control board 12. When the sensing unit 13 detects the signal indicating the upper cover 80 being closed on the body 1, the oxygen-enriched gas in the oxygen storage assembly 4 cannot flow to the oxygen suction nozzle 6 through the outlet assembly 5, i.e., the sensing unit 13 can control to close the oxygen outlet passage 503 via the control board 12. During actual use, when the user needs the oxygen concentrator to supply oxygen, they only need to open the upper cover 80. At this time, the sensing unit 13 may detect that the upper cover 80 is open and immediately transmit the signal to the control board 12 to open the oxygen outlet passage 503. The oxygen-enriched gas in the oxygen storage tank 4a may be delivered to the oxygen suction nozzle 6 through the oxygen outlet passage 503. Since the oxygen suction nozzle 6 is exposed to the user, the user may only need to approach the oxygen suction nozzle 6 to start using oxygen, achieving rapid oxygen supply between the concentrator and the user. When the user no longer needs to continue using oxygen, they simply close the upper cover 80. The sensing unit 13 may detect the upper cover 80 closing and immediately transmit the signal to the control board 12 to close the oxygen outlet passage 503, achieving rapid separation between the handheld portable oxygen concentrator and the user. By establishing a linkage between the opening/closing of the upper cover 80 and oxygen supply, convenience of use may be greatly improved, especially suitable for intermittent oxygen use scenarios where an oxygen supply duration is short but a frequency is high. Additionally, after the upper cover 80 is closed, the oxygen suction nozzle 6 may be located within the cavity formed by the upper cover 80 and the body 1, allowing the oxygen suction nozzle 6 to be carried along with the oxygen concentrator, making use more convenient. The cavity formed by the upper cover 80 and the body 1 may also effectively ensure hygiene of the oxygen suction nozzle 6. The entire handheld oxygen concentrator may present a structure of a continuously oxygen-producing “oxygen bottle.” When used in a single-handed holding state, opening and closing operations of the upper cover 80 may be performed during movement, achieving use-as-you-take, adapting to more usage scenarios.

Based on the button 17 and sensing unit 13 on the control board 12, as well as the opening or closing of the upper cover 80, in some embodiments, the handheld portable oxygen concentrator may also provide any of the following oxygen generation methods.

In a first method, after pressing the control button 17, oxygen generation may be started. This method can enable rapid oxygen generation.

In a second method, the control button 17 is pressed, the open/closed state of the upper cover 80 may be detected. When the upper cover 80 is detected to be in the open state, oxygen generation may be delayed until the upper cover 80 is closed. When the upper cover 80 is detected to be in the closed state, the oxygen generation may be started. In this method, by detecting the open/closed state of the upper cover 80, oxygen generation may be temporarily suspended when the upper cover 80 is open, preventing noise generated during oxygen generation from affecting the oxygen use experience. Oxygen generation may start later when the upper cover 80 is detected to be in the closed state, i.e., after oxygen use stops.

In a third method, after pressing the control button 17, the gas pressure inside the oxygen storage tank 4a may be detected. When the pressure is detected to be below 110 kPa, oxygen generation may be started. Generally, a gas pressure of 110 kPa may be an upper limit for oxygen storage pressure in the oxygen storage tank 4a. When the gas pressure inside the oxygen storage tank 4a is detected to be below 110 kPa, oxygen generation may be directly started, the gas pressure inside the oxygen storage tank 4a may always be ensured sufficient.

Based on the above methods, in some embodiments, an oxygen supply method may be provided, which may be applied to the handheld portable oxygen concentrator, including the following operations. After opening the upper cover 80, the oxygen suction nozzle 6 may supply oxygen; and after closing the upper cover 80, the oxygen suction nozzle 60 may stop supplying oxygen. As a most basic oxygen supply method, oxygen may be supplied once the upper cover 80 is opened, and oxygen may be stopped to be supplied once the upper cover 80 is closed. The entire oxygen use process may be convenient and simple, achieving the user needs for rapid oxygen supply and rapid separation between the oxygen concentrator and the user.

For the spray oxygen supply method, the button 17 may be integrated with a spray oxygen switch. When the spray oxygen switch is pressed to achieve spray oxygen, to prevent spray oxygen due to accidental pressing of the spray oxygen switch when the upper cover 80 is not yet open, the following scheme can be adopted. A spray oxygen switch may be arranged on the body 1. After opening the upper cover 80 and pressing the spray oxygen switch, the oxygen suction nozzle 6 may perform spray oxygen. During actual use, both conditions of “upper cover open” and “spray oxygen switch pressed” need to be satisfied simultaneously to achieve spray oxygen.

Additionally, to prevent oxygen waste due to accidental opening of the upper cover 80 when there is no oxygen demand, the following scheme can be adopted. A breathing detection sensor electrically connected to the control board 12 may be arranged, and the breathing detection sensor may be arranged within the cavity formed by the upper cover 80 and the body 1. After the upper cover 80 is open and gas exhaled by the user is detected by the breathing detection sensor, the oxygen suction nozzle 6 may supply oxygen. When there is no oxygen demand, even if the upper cover 80 may be accidentally opened, because a distance between the user's nose and the oxygen suction nozzle 6 may be far, the user's exhaled breath may not be detected by the breathing detection sensor. In this case, even if the upper cover 80 is opened, the oxygen suction nozzle 6 may not supply oxygen. Only when the breathing detection sensor detects the user's exhaled breath may the oxygen suction nozzle 6 supply oxygen.

Regarding the molecular sieve tank 30, oxygen storage tank 4a, and pre-conditioning tank 44 specifically, the molecular sieve tank 30 may be of a structure of a conventional molecular sieve tank to achieve oxygen production. Oxygen may be continuously produced by the molecular sieve tank 30 and delivered to the oxygen storage tank 4a, forming a continuously oxygen-producing “oxygen bottle” structure. After the oxygen storage tank 4a is filled with sufficient oxygen, spray oxygen supply or continuous oxygen supply may be achieved. Particularly, spray-type oxygen supply may allow the user to inhale more oxygen in a very short time, expanding application scenarios of the handheld portable oxygen concentrator. For example, a hypoxic person may quickly inhale oxygen in a short time. It can also be used in scenarios for refreshing and clearing the mind. When oxygen is needed, the user may hold the handheld portable oxygen concentrator with one hand, move the handheld portable oxygen concentrator to the nose or mouth, and spray oxygen once or several times. After use, the handheld portable oxygen concentrator may be placed aside casually, achieving use-as-you-take. The internal molecular sieve tank 30 can continuously deliver oxygen-enriched gas to the oxygen storage tank 4a to meet oxygen inhalation demands.

As shown in FIGS. 3 and 4, two molecular sieve tanks 30 may be provided. The oxygen storage tank 4a, as a main component of the handheld portable oxygen concentrator, may store oxygen-enriched gas, which may be directly inhaled by the user to improve hypoxia symptoms. On an gas path through which oxygen-enriched gas may flow into the oxygen storage tank 4a, the pre-conditioning tank 44 may be arranged. The pre-conditioning tank 44 may be communicated with the molecular sieve tanks 30 through the delivery passage 500 and communicated with the oxygen storage tank 4a through the delivery passage 500. During the oxygen generation process, gas from the molecular sieve tanks 30 may first accumulated in the pre-conditioning tank 44, forming a certain pressure before being sprayed into the oxygen storage tank 4a via an electromagnetic valve, thereby increasing a speed of gas entering the oxygen storage tank 4a, promoting oxygen accumulation and gas pressure increase in the oxygen storage tank 4a, meeting requirements on an oxygen outlet flow rate under continuous oxygen outlet mode and the spray oxygen flow requirements under intermittent oxygen outlet mode. The pre-conditioning tank 44 may be an independent structure with gas capacity, a gas storage chamber on the gas path, a portion of an accommodation space of the oxygen storage tank 4a, or a portion of an accommodation space at the oxygen outlet end of the molecular sieve tanks 30. It may only need to satisfy that the oxygen-enriched gas may flow into the pre-conditioning tank 44 before entering the oxygen storage tank 4a.

When the pre-conditioning tank 44 is arranged inside the oxygen storage tank 4a, the pre-conditioning tank 44 may not occupy extra space, which may be beneficial for the compactness and miniaturization of the device. Therefore, the pre-conditioning tank 44 may be fixed inside the oxygen storage tank 4a, or merely arranged inside the oxygen storage tank 4a, or a portion of the space inside the oxygen storage tank 4a may directly serve as the pre-conditioning tank 44. The oxygen-enriched gas entering the oxygen storage tank 4a may reach a certain gas pressure in the pre-conditioning tank 44, and the pressure setting may be generally determined during product manufacturing. Additionally, using the pre-conditioning tank 44 for pressure accumulation may also reversely keep a pressure in the molecular sieve tank 30 within a high-pressure range, making a gas flow speed inside the molecular sieve tank 30 relatively slow. With a reduced volume of a molecular sieve of the molecular sieve tank 30, this can ensure sufficient contact between air and the molecular sieve, ensuring adequate nitrogen adsorption and improving oxygen generation concentration, i.e., increasing an oxygen content of the oxygen-enriched gas entering the pre-conditioning tank 44. Simultaneously, after increasing the gas pressure of the oxygen-enriched gas via the pre-conditioning tank 44, the gas pressure of the oxygen-enriched gas entering the oxygen storage tank 4a may be also synchronously increased. Besides ensuring uniform mixing of the oxygen-enriched gas concentration inside the oxygen storage tank 4a, it may also allow the gas pressure of the oxygen-enriched gas inside the oxygen storage tank 4a to meet a demand for large-volume outward spray oxygen in a short time.

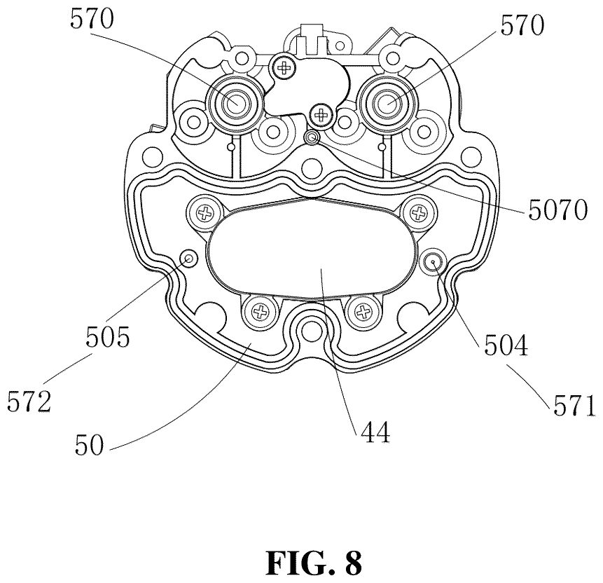

To save space, the outlet assembly 5 may include the upper passage plate 50. As shown in FIGS. 8-12, both the molecular sieve tank 30 and the oxygen storage tank 4a may be connected to the upper passage plate 50. The delivery passage 500 may be integrated inside the upper passage plate 50, including a first oxygen passage 573, a second oxygen passage 574, and an oxygen inlet passage 502. That is, the molecular sieve tank 30 may be communicated with the pre-conditioning tank 44 through the first oxygen passage 573 or second oxygen passage 574 of the upper passage plate 50. The pre-conditioning tank 44 may be communicated with the oxygen storage tank 4a through the oxygen inlet passage 502 of the upper passage plate 50. The first oxygen passage 573 and second oxygen passage 574 may correspond to the two molecular sieve tanks 30 respectively. An end portion of each of the first oxygen passage 573 and second oxygen passage 574 communicated to a respective pre-conditioning tank 44 may be arranged with a check valve 501 facing the pre-conditioning tank 44. The other end portion of each of the first oxygen passage 573 and second oxygen passage 574 may be communicated with the respective molecular sieve tank 30 via a through hole. Gas from each molecular sieve tank 30 may first enter the pre-conditioning tank 44 through a respective one of the first oxygen passage 573 and second oxygen passage 574. Between the pre-conditioning tank 44 and the oxygen inlet passage 502, a communication hole 508 extending along the thickness direction of the upper passage plate 50 may be also formed. Gas from the pre-conditioning tank 44 may enter the oxygen inlet passage 502 through the communication hole 508. A pulse electromagnetic valve 51 may also be arranged in the oxygen inlet passage 502, allowing oxygen to finally enter the oxygen storage tank 4a for storage via the pulse electromagnetic valve 51, reducing use of tubing, making the overall structure more compact and conducive to reducing the overall volume.

The pre-conditioning tank 44 may be integrally formed with the oxygen storage tank 4a as a one-piece structure or independently arranged. For convenient assembly, both the pre-conditioning tank 44 and the oxygen storage tank 4a may be arranged with an open upper end. During mounting, the pre-conditioning tank 44 may be fixed to a bottom face of the upper passage plate 50 with screws. An upper end of the oxygen storage tank 4a may be sealed to the bottom face of the upper passage plate 50, enclosing the pre-conditioning tank 44 inside the oxygen storage tank 4a. This may ensure both the pre-conditioning tank 44 and the oxygen storage tank 4a may be sealed to the upper passage plate 50, reducing assembly difficulty.

To utilize the upper passage plate 50 to simultaneously achieve oxygen inlet and outlet for the oxygen storage tank 4a, as shown in FIG. 8, the bottom portion of the upper passage plate 50, located within the oxygen storage tank 4a, may define an oxygen inlet interface 504 and an oxygen outlet interface 505. The top portion of the upper passage plate 50 may define an oxygen outlet port 506. An upper end portion of the oxygen inlet interface 504 may be communicated with the oxygen inlet passage 502. An upper end portion of the oxygen outlet interface 505 may be communicated with the oxygen outlet port 506 through the oxygen outlet passage 503. Similarly, an oxygen outlet electromagnetic valve 52 may be arranged in the oxygen outlet passage 503. The oxygen outlet port 506 may finally be communicated with the oxygen supply tube 62 of the oxygen suction nozzle 6. Integrating the oxygen inlet passage 502 and oxygen outlet passage 503 of the oxygen storage tank 4a on the upper passage plate 50 may make the gas passage structure more compact, achieving device miniaturization.

Since both the oxygen inlet interface 504 and oxygen outlet interface 505 are formed on the upper passage plate 50 and are formed close to each other, gas entering the oxygen storage tank 4a from the oxygen inlet interface 504 may immediately exit from the oxygen outlet interface 505 without mixing with other gas in the oxygen storage tank 4a, leading to an uneven outlet oxygen concentration. Therefore, in some embodiments, an outlet tube 5050 extending to a bottom portion of the oxygen storage tank 4a may be arranged at a lower end of the oxygen outlet interface 505. Oxygen may enter the oxygen storage tank 4a from the upper passage plate 50 above, and may be then exported outward from the bottom portion of the oxygen storage tank 4a through the outlet tube 5050. In an initial stage of oxygen generation, with a cooperation of the pre-conditioning tank 44 and the pulse electromagnetic valve 51, oxygen accumulation may be accelerated to achieve increased oxygen concentration in the oxygen storage tank 4a. After that, uniform oxygen concentration for supply may be ensured.

To monitor an gas pressure in the pre-conditioning tank 44, the upper passage plate 50 may also define a detection air passage 507. One end of the detection air passage 507 may be communicated with the pre-conditioning tank 44 through the communication hole 508. A detection port 5070 penetrating the upper passage plate 50 may be formed at the other end of the detection air passage 507. A pressure detection device may be mounted at the detection port 5070 to detect the gas pressure in the pre-conditioning tank 44, and then opening the pulse electromagnetic valve 51 to send oxygen into the oxygen storage tank 4a when the gas pressure reaches a set value, stability of a pre-pressurization in the pre-conditioning tank 44 may be ensured. Additionally, to detect an oxygen concentration in the oxygen storage tank 4a, an access port 40 for connecting an external oxygen concentration detector may be also arranged on the oxygen storage tank 4a. Because a bottom outlet form is adopted in the present disclosure, the access port 40 may be specifically formed at the bottom portion of the oxygen storage tank 4a.

Regarding the mounting of the oxygen storage tank 4a, in some embodiments, the oxygen storage tank 4a may be fixed on the support frame 20 below. An interior of the support frame 20 may receive the air compressing member 21. One side of the top portion of the support frame 20 may be used to mount the intake assembly 9, and the other side of the top portion of the support frame 20 may be connect the bottom portion of the oxygen storage tank 4a. The bottom portion of the oxygen storage tank 4a may also define a clearance space 42 for accommodating the intake assembly 9. The oxygen storage tank 4a may be fixed to the top portion of the support frame 20 with screws to ensure a mounting stability of the oxygen storage tank 4a. After the oxygen storage tank 4a is fixed, the intake assembly 9 may be precisely located within the clearance space 42 at the bottom portion of the oxygen storage tank 4a, saving vertical space and ensuring structural compactness.

Since the oxygen storage tank 4a has a certain volume and relatively high structural strength, the oxygen storage tank 4a may serve as a mounting foundation for the upper passage plate 50 above. For convenient positioning and mounting, an upper positioning rim 54 may be arranged on a portion of the bottom portion of the upper passage plate 50 connected to the oxygen storage tank 4a. The upper passage plate 50 may be matched and connected with the open upper end of the oxygen storage tank 4a through the upper positioning rim 54 and may be fixed to the oxygen storage tank 4a with screws.

After the oxygen storage tank 4a and the upper passage plate 50 are fixed to each other, the upper and lower ends of the two molecular sieve tanks 30 may be respectively fixed to the upper passage plate 50 and the intake assembly 9. To reduce lateral space occupation, two arc-shaped recesses 43 may be formed on a side of the oxygen storage tank 4a close to the molecular sieve tanks 30. The two molecular sieve tanks 30 may be respectively located within the two arc-shaped recesses 43, ensuring that outer peripheries of the molecular sieve tanks 30 and the oxygen storage tank 4a may not exceed a top edge of the support frame 20.

Regarding the outlet assembly 5, pulse electromagnetic valve 51, oxygen outlet electromagnetic valve 52, and equalizing electromagnetic valve 53, specifically, the outlet assembly 5 may include the upper passage plate 50 communicated to the two molecular sieve tanks 30 and the oxygen storage tank 4a through internal passages. The top portion of the upper passage plate 50 may be arranged with a valve bracket 55. The pulse electromagnetic valve 51, oxygen outlet electromagnetic valve 52, and equalizing electromagnetic valve 53 which may be arranged in an equilateral triangle surrounding the central oxygen outlet port 506 may be arranged on the valve bracket 55. The pulse electromagnetic valve 51 may be arranged in the delivery passage 500 from oxygen outlet ends of the two molecular sieve tanks 30 to the oxygen storage tank 4a. The oxygen outlet electromagnetic valve 52 may be arranged in the oxygen outlet passage 503 from the oxygen storage tank 4a to the oxygen outlet port 506. The equalizing electromagnetic valve 53 may be arranged in a passage between the oxygen outlet ends of the two molecular sieve tanks 30. The pulse electromagnetic valve 51, oxygen outlet electromagnetic valve 52, and equalizing electromagnetic valve 53 may be three identical two-position two-way electromagnetic valves. The equilateral triangle arrangement may be suitable for oxygen concentrator structures with circular or triangular cross-sections, making the overall structure compact and allowing full utilization of the lateral space of the upper passage plate 50 to integrate gas passages internally, realizing air passages for oxygen inlet, oxygen outlet of the oxygen storage tank 4a, and pressure equalization of the molecular sieve tanks 30. Additionally, arranging the three electromagnetic valves together may also facilitate wiring, avoiding messy wiring issues, improving convenience for maintenance and repair, and forming a low overall height after arranging the three electromagnetic valves on the valve bracket 55, which may be beneficial for reducing an overall structural height. Furthermore, integrating the electromagnetic valves may form a unit module for integrated overall assembly.

As shown in FIGS. 7, 9, 12, and 13, to facilitate mounting of the valve bracket 55 and the three electromagnetic valves, the valve bracket 55 may be of a triangular frame structure, including a first corner 554, a second corner 555, and a third corner 556. Each of the three corners, including the first corner 554, second corner 555, and third corner 556, may define a connection hole 550. The valve bracket 55 may be fixed to the upper passage plate 50 with screws passing through the connection hole 550. The valve bracket 55 may include a first side wall 551, a second side wall 552, and a third side wall 553. Each of the three side walls, including the first side wall 551, second side wall 552, and third side wall 553 may define a screw hole. The pulse electromagnetic valve 51, oxygen outlet electromagnetic valve 52, and equalizing electromagnetic valve 53 may be fixed to the three side walls of the valve bracket 55 with screws matched with the screw holes.

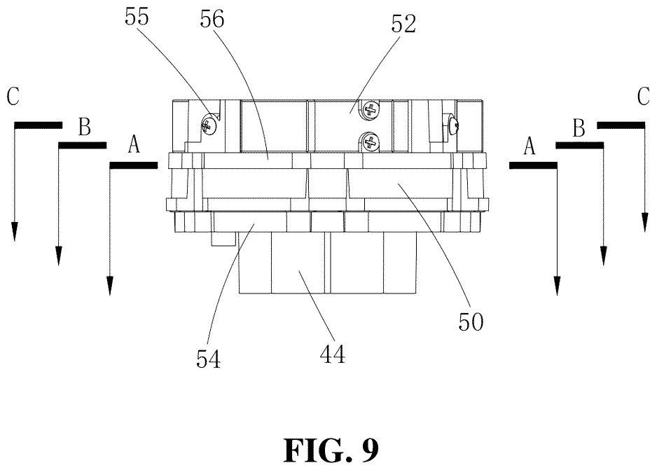

Regarding a gas passage communication between the pulse electromagnetic valve 51 and the upper passage plate 50, as shown in FIGS. 9-13, the delivery passage 500 may include the oxygen inlet passage 502. The oxygen inlet passage 502 may be formed at a center portion of a bottom face of the valve bracket 55. The first corner 554 at the bottom face may define an oxygen inlet through hole 5540. The first side wall 551 of the valve bracket 55 may define a first passage 5511 and a second passage 5512. The pulse electromagnetic valve 51 may be arranged on the first side wall 551. Each of two ports of the pulse electromagnetic valve 51 may be communicated with a respective one of one end of the first passage 5511 and one end of the second passage 5512. The other end of the first passage 5511 may be communicated with one end of the oxygen inlet passage 502 via a drilled hole. The other end of the second passage 5512 may also be communicated with one end of the oxygen inlet through hole 5540 via a drilled hole. The other ends of the oxygen inlet passage 502 and the oxygen inlet through hole 5540 may be communicated with the molecular sieve tanks 30 and the oxygen storage tank 4a respectively through the upper passage plate 50. Specifically, before oxygen enters the oxygen storage tank 4a, oxygen may first enter the pre-conditioning tank 44 inside the oxygen storage tank 4a. After the oxygen in the pre-conditioning tank 44 reaches a certain gas pressure, the pulse electromagnetic valve 51 may be controlled to pulse on or off, allowing the oxygen in the pre-conditioning tank 44 to be sprayed into the oxygen storage tank 4a. The oxygen in the oxygen storage tank 4a may only be output outward for user use.

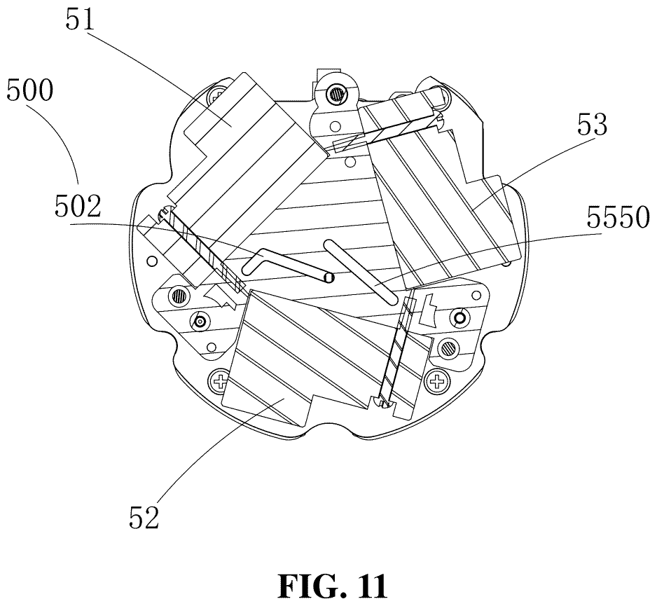

Regarding a gas passage communication between the oxygen outlet electromagnetic valve 52 and the upper passage plate 50, as shown in FIGS. 11, 12, and 13, the oxygen outlet passage 503 may be arranged at the center portion of the bottom face of the valve bracket 55. The second corner 555 of the bottom face may define an oxygen outlet through hole 5550. The second side wall 552 of the valve bracket 55 may define a third passage 5523 and a fourth passage 5524. The oxygen outlet electromagnetic valve 52 may be arranged on the second side wall 552. Each of two ports of the oxygen outlet electromagnetic valve 52 may be communicated with a respective one of one end of the third passage 5523 and one end of the fourth passage 5524. The other end of the third passage 5523 may be communicated with one end of the oxygen outlet passage 503 via a drilled hole. The other end of the fourth passage 5524 also may be communicated with one end of the oxygen outlet through hole 5550 via a drilled hole. The other end of the oxygen outlet passage 503 may be communicated with the oxygen outlet port 506 via a drilled hole. The other end of the oxygen outlet through hole 5550 may be communicated with the oxygen storage tank 4a through the upper passage plate 50. The oxygen outlet electromagnetic valve 52 may realize oxygen spray from the oxygen storage tank 4a out of the oxygen outlet port 506. By controlling an open/closed state of the oxygen outlet electromagnetic valve 52, pulse oxygen supply or continuous oxygen supply modes may be achieved.

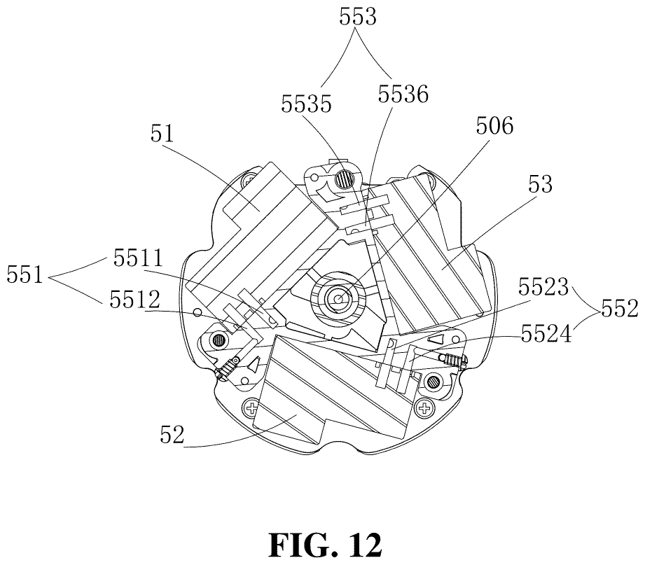

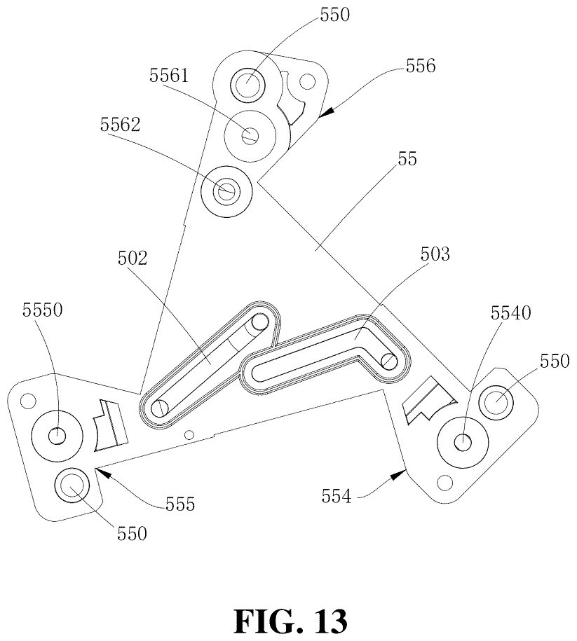

Regarding a gas passage communication between the equalizing electromagnetic valve 53 and the upper passage plate 50, as shown in FIGS. 12 and 13, the third corner 556 of the bottom face of the valve bracket 55 may define a first equalizing hole 5561 and a second equalizing hole 5562. Lower ends of the first equalizing hole 5561 and the second equalizing hole 5562 may be communicated with the oxygen outlet ends of the two molecular sieve tanks 30 respectively through the upper passage plate 50. The third side wall 553 of the valve bracket 55 may define a fifth passage 5535 and a sixth passage 5536. The equalizing electromagnetic valve 53 may be arranged on the third side wall 553. Two ports of the equalizing electromagnetic valve 53 may be communicated with one end of the fifth passage 5535 and one end of the sixth passage 5536 respectively. The other ends of the fifth passage 5535 and the sixth passage 5536 may be communicated with upper ends of the first equalizing hole 5561 and the second equalizing hole 5562 respectively.

To facilitate arrangements of the oxygen inlet passage 502 and oxygen outlet passage 503, an upper sealing plate 56 may be arranged between the bottom face of the valve bracket 55 and a top face of the upper passage plate 50. Each of the oxygen inlet passage 502 and oxygen outlet passage 503 may be a groove formed on the bottom face of the valve bracket 55 and sealed in cooperation with the upper sealing plate 56. This cooperation arrangement of the grooves and the upper sealing plate 56 may reduce machining difficulty of the passages, save costs, and improve assembly efficiency and accuracy.

Regarding an air passage communication among the upper passage plate 50, the molecular sieve tank 30, oxygen storage tank 4a, and valve bracket 55, as shown in FIGS. 8, 10, 11, and 12, the molecular sieve tank 30 and oxygen storage tank 4a may be both arranged on the bottom face of the upper passage plate 50. The upper passage plate 50 may define oxygen inlets 570, a gas inlet through hole 571, and a gas outlet through hole 572, each of the oxygen inlets 570, gas inlet through hole 571, and gas outlet through hole 572 may penetrate the upper passage plate 50 from an upper face of the upper passage plate 50 to a lower face of the upper passage plate 50. The delivery passage 500 may include a first oxygen passage 573, a second oxygen passage 574, a first equalizing passage 575, and a second equalizing passage 576. Each of the first oxygen passage 573, second oxygen passage 574, first equalizing passage 575, and second equalizing passage 576 may formed on the top face of the upper passage plate 50. Lower ends of two oxygen inlets 570 may be respectively aligned with oxygen outlet ends of the two molecular sieve tanks 30. Upper ends of two oxygen inlets 570 may be communicated with one end of the first oxygen passage 573 and one end of the second oxygen passage 574 respectively. The other ends of the first oxygen passage 573 and second oxygen passage 574 may be communicated with the oxygen inlet passage 502. One end of the first equalizing passage 575 and one end of the second equalizing passage 576 may be communicated with the first oxygen passage 573 and second oxygen passage 574 respectively. The other ends of the first equalizing passage 575 and the second equalizing passage 576 may be communicated with lower ends of the first equalizing hole 5561 and the second equalizing hole 5562 respectively. The lower ends of the gas inlet through hole 571 and gas outlet through hole 572 may be communicated with the oxygen storage tank 4a. The lower end of the gas inlet through hole 571 may be the oxygen inlet port 504, and the lower end of the gas outlet through hole 572 may be the oxygen outlet port 505. The upper ends of the gas inlet through hole 571 and gas outlet through hole 572 may be communicated with the oxygen inlet through hole 5540 and oxygen outlet through hole 5550 respectively. Similarly, for convenient machining, each of the first oxygen passage 573, second oxygen passage 574, first equalizing passage 575, and second equalizing passage 576 may be a groove formed on the top face of the upper passage plate 50, and further sealed in cooperation with the upper sealing plate 56.

Regarding the intake assembly 9, specifically, as shown in FIGS. 14-17, the intake assembly 9 may include a lower passage plate 90, a first electromagnetic valve 91, and a second electromagnetic valve 92. The lower passage plate 90 may define an intake passage 900, connection passages 901, and an exhaust passage 902 which may be mutually isolated to each other. The number of connection passages 901 may be two. Each of intake ends of the two connection passages 901 may be communicated with a respective one of the intake passage 900 and the exhaust passage 902 through a respective one of the first electromagnetic valve 91 and the second electromagnetic valve 92. When the first electromagnetic valve 91 or the second electromagnetic valve 92 is de-energized, a corresponding connection passage 901 may be communicated with the intake passage 900. When energized, a corresponding connection passage 901 may be communicated with the exhaust passage 902. To facilitate connection between the lower passage plate 90 and other equipment, the lower passage plate 90 may define an air inlet port 903, an exhaust port 904, and two air outlet ports 905. The air inlet port 903 may be communicated with the intake passage 900. The exhaust port 904 may be communicated with the exhaust passage 902. The two air outlet ports 905 may communicated with outlet ends of the two connection passages 901 respectively. The air inlet port 903 may be communicated to the air compressing member 21, allowing gas generated by the air compressing member 21 to enter the intake passage 900. The two air outlet ports 905 may be communicated to intake ends of the two molecular sieve tanks 30 respectively, providing gas to the molecular sieve tanks 30. The exhaust port 904 may discharge desorbed gas from the molecular sieve tanks 30 out of the intake assembly 9.

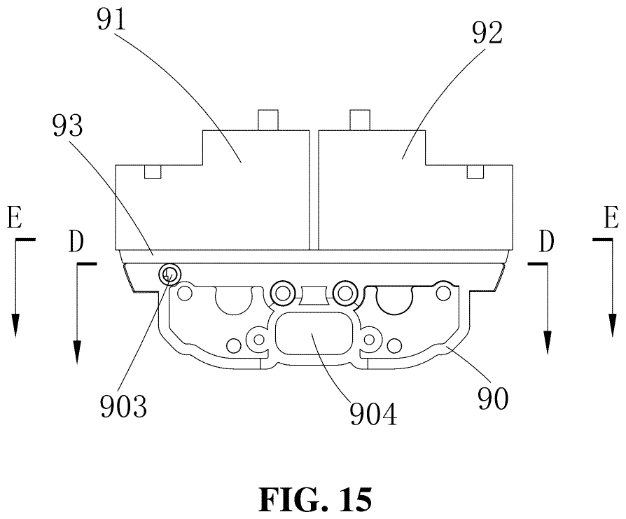

A working process of the intake assembly 9 of the handheld portable oxygen concentrator may be as follows. As shown in FIGS. 15, 16, and 17, when both the first electromagnetic valve 91 and the second electromagnetic valve 92 are de-energized, each of the two connection passages 901 may be communicated with the intake passage 900 through a respective one of the first electromagnetic valve 91 and second electromagnetic valve 92. Since the intake passage 900 is communicated to the air compression assembly 2 through the air inlet port 903, when the oxygen concentrator is not working, external air cannot enter the air compression assembly 2 and thus cannot enter the molecular sieve tank 30 through the intake assembly 9, avoiding a problem of molecular sieve absorbing moisture and failing due to contact with external air through the exhaust port 904. When the oxygen concentrator is working, the first electromagnetic valve 91 and the second electromagnetic valve 92 may be alternately energized and de-energized, for example, the first electromagnetic valve 91 may be de-energized, and the second electromagnetic valve 92 may be energized. At this time, the left connection passage 901 may be communicated with the intake passage 900, and the right connection passage 901 may be communicated with the exhaust passage 902. The compressed gas generated by the air compression assembly 2 may enter one molecular sieve tank 30 sequentially through the air inlet port 903, intake passage 900, left connection passage 901, and left air outlet port 905. Nitrogen may be adsorbed, and the remaining oxygen-enriched gas may mostly enter the oxygen storage tank 4a after leaving the molecular sieve tank 30, with a small portion entering the other molecular sieve tank 30. This small portion of gas may enter the exhaust port 904 sequentially through the right air outlet port 905, right connection passage 901, and exhaust passage 902, performing backflushing on the other molecular sieve tank 30. The first electromagnetic valve 91 and the second electromagnetic valve 92 may operate alternately according to the above process, enabling continuous air intake, gas outlet, and exhaust for the two molecular sieve tanks 30, thereby achieving continuous oxygen generation.

By laying the first electromagnetic valve 91 and the second electromagnetic valve 92 flat on a front side of the lower passage plate 90, a vertical space occupation of the intake assembly 9 may be reduced, which may be beneficial for the miniaturization of the handheld portable oxygen concentrator. Additionally, through the structural arrangement of the intake passage 900, connection passages 901, and exhaust passage 902, the two molecular sieve tanks 30 may share the intake passage 900 and exhaust passage 902, reducing the number of air passages and making the structure more compact and simple. Moreover, with a cooperation of the electromagnetic valves and the gas passage structure, when the device is in an off state, the air compressing member 21 may be also closed. The intake ends of both molecular sieve tanks 30 may be communicated to the air compressing member 21, thus preventing the molecular sieve tanks 30 from contacting external air through the exhaust port 904, which may cause the molecular sieve to absorb moisture and fail.

To facilitate arrangement of gas passages on the lower passage plate 90, in some embodiments, a lower sealing plate 93 may be arranged between the first electromagnetic valve 91 and a side face of the lower passage plate 90, and between the second electromagnetic valve 92 and the side face of the lower passage plate 90. The intake passage 900, connection passages 901, and exhaust passage 902 may be all grooves formed on the side face of the lower passage plate 90, which are then sealed by the lower sealing plate 93. This may allow easy machining of each gas passage on the lower passage plate 90 with a milling cutter, reducing production costs. The lower sealing plate 93 may define through holes at positions corresponding to interfaces of the electromagnetic valve 91 and the second electromagnetic valve 92. The first electromagnetic valve 91 and the second electromagnetic valve 92 may be fixed to the lower passage plate 90 with screws, ensuring a sealing effect between the lower sealing plate 93 and the lower passage plate 90. Each of the air inlet port 903, exhaust port 904, and air outlet ports 905 may be an exposed interface on a surface of the lower passage plate 90, communicated with the corresponding intake passage 900, exhaust passage 902, and connection passages 901 via drilled holes, facilitating connection with other equipment.

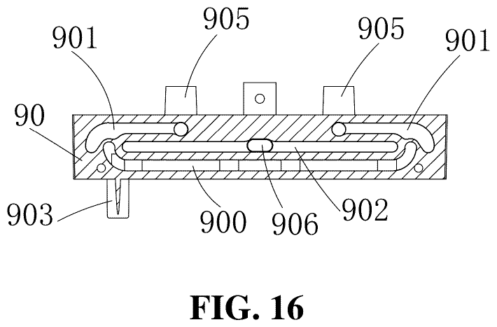

Since the electromagnetic valves, including the first electromagnetic valve 91 and the second electromagnetic valve 92, have a certain height, to avoid a space waste, the lower passage plate 90 may be arranged to have a same height as the electromagnetic valves. Then, the intake passage 900, exhaust passage 902, and connection passages 901 may be formed parallel to each other and sequentially distributed from bottom to top along a height direction of the lower passage plate 90. The two connection passages 901 may be located at both ends of the intake passage 900. Additionally, as shown in FIG. 16, to adapt to the interfaces of the electromagnetic valves, ends of the intake passage 900 may be bent upward, and the intake ends of the connection passages 901 may be bent downward to a position level with ends of the exhaust passage 902.

Furthermore, the intake passage 900, exhaust passage 902, and connection passages 901 may be all symmetrically arranged about a central axis of the lower passage plate 90. An air guide hole 906 may be formed at a middle portion of the exhaust passage 902 and may be communicated with the exhaust port 904. The symmetrical gas passage structure may ensure that the air intake and exhaust paths of the two molecular sieve tanks 30 may be the same, ensuring the two molecular sieve tanks 30 may be in a same working state, which may be conducive to continuous and stable operation of the device.

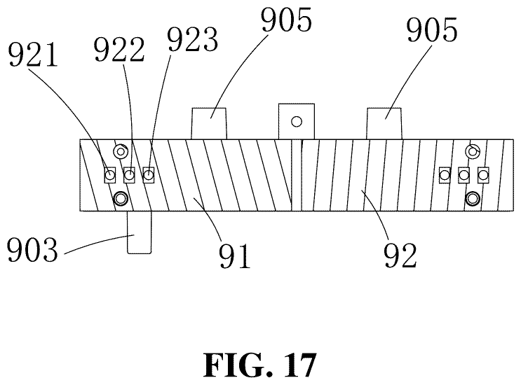

Regarding a specific connection manner between the electromagnetic valves and the lower passage plate 90, as shown in FIGS. 16 and 17, each of the first electromagnetic valve 91 and the second electromagnetic valve 92 may be a two-position three-way valve. A valve body of the two-position three-way valve may define a first valve passage 921, a second valve passage 922, and a third valve passage 923. Each first valve passage 921 may be aligned with the intake end of a respective connection passage 901. The second valve passage 922 may be aligned with the end of the intake passage 900. The third valve passage 923 may be aligned with the end of the exhaust passage 902. The valve body may have two working positions. In the first position, the first valve passage 921 may be communicated with the second valve passage 922, and the first valve passage 921 may be communicated with the third valve passage 923.

Since the intake assembly 9 needs to be communicated to the air compression assembly 2, the intake assembly 9 may be integrally formed with the air compression assembly 2 as a one-piece structure. As shown in FIG. 14, the air compression assembly 2 may include the support frame 20 and the air compressing member 21 (e.g., a miniature air compressor) arranged within the support frame 20. The support frame 20 may include a base plate 201 and a top plate 202 which may be mutually supported by each other, with a hollow middle portion for receiving the air compressing member 21. The air compressing member 21 may be located within the support frame 20. Each of the lower passage plate 90, first electromagnetic valve 91, and second electromagnetic valve 92 may be arranged on the top plate 202 of the support frame 20. The air compressing member 21 may be communicated with the air inlet port 903 of the lower passage plate 90 via a pipe. A filter chamber 2010 protruding upwardly may be arranged on the base plate 201 of the support frame 20. An air intake grille 2011 may be arranged on a top portion of the filter chamber 2010. The filter chamber 2010 may be communicated with a gas inlet of the air compressing member 21, used to filter gas entering the air compressing member 21.

In some embodiments, the air compressing member 21 may be particularly an L-shaped single-cylinder air compressor. The L-shaped single-cylinder air compressor may refer to an air compressor where an axis of a motor may be perpendicular to an axis of a piston cylinder. Compared to straight cylindrical air compressors, this L-shaped single-cylinder air compressor may have a structure that may be more concentrated towards the center, resulting in smaller lateral space occupation. At the same time, the piston cylinder may have a sufficiently large compression chamber, which may increase a gas flow rate of the air compressing member 21. The air compressing member 21 may be mounted inside the support frame 20 via an elastic member. Specifically, the air compressing member 21 may be suspended inside the support frame 20, providing sufficient support and limitation while reducing vibration transmitted from the air compressing member 21 to the support frame 20, thereby improving the vibration damping effect of the entire air compression assembly 2. After the air compressing member 21 is mounted, an edge of the air compressing member 21 may not extend beyond an edge of the support frame 20. Especially in handheld portable oxygen concentrators with circular cross-sections, integrating the air compressing member 21 may occupy minimal space, which may be beneficial for further reducing a cross-sectional size of the handheld portable oxygen concentrator, achieving extreme miniaturization of the body 1 of the handheld portable oxygen concentrator.

Regarding a structure of the support frame 20, as shown in FIGS. 4 and 14, the support frame 20 may include a top plate 202 and a base plate 201. Upper and lower ends of the air compressing member 21 may be respectively fixed to the top plate 202 and the base plate 201 via elastic structures. Upper pillars 2023 may be arranged on a bottom face of the top plate 202 and may protrude from the bottom face of the top plate 202. Lower pillars 2013 may be arranged on a top face of the base plate 201 and may protrude from the top face of the base plate 201. The upper pillars 2023 may be aligned and fixed to the corresponding lower pillars 2013, such as by plugging or bolting. When mounting the air compressing member 21, the air compressing member 21 may be first mounted into the base plate 201, then the top plate 202 may be mounted onto the base plate 201. Using a combined structure of top plate 202 and base plate 201 may facilitate mounting of the air compressing member 21, and additionally reduce shield around the air compressing member 21, exposing a surface of the air compressing member 21 to improve a heat dissipation effect of the air compressing member 21. To ensure an overall structural strength of the support frame 20, the number of the upper pillars 2023 may be three, and the number of the lower pillars 2013 may be three; the upper pillars 2023 may be evenly distributed along a circumference of the top plate 202, and the lower pillars 2013 may be evenly distributed along a circumference of the base plate 201.

For the entire handheld portable oxygen concentrator, to reduce device size, the support frame 20 may serve as a mounting foundation for other components besides being used to mount the air compressing member 21. For example, mounting members for mounting the molecular sieve tank 30, oxygen storage tank 4a, and intake assembly 9 may be arranged on the top face of the top plate 202, and mounting members for mounting the power supply assembly 7 may be arranged on the bottom face of the base plate 201, thereby reducing other frames and improving device compactness.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

What is claimed is:

1. A handheld portable oxygen concentrator, comprising:
a body of a size suitable for single-handed holding and use, wherein the body comprises a top face, a bottom face, and a side face, the top face and the bottom face are arranged opposite each other in a height direction of the body, and the side face connects the top face and the bottom face;
an oxygen generation and storage assembly, arranged in the body and comprising an air compression assembly, at least one molecular sieve tank, an intake assembly, an oxygen storage assembly, an outlet assembly, and a control board; wherein the at least one molecular sieve tank is vertically arranged above the air compression assembly, a projection contour of the at least one molecular sieve tank on a first projection plane is completely or partially overlapped with a projection contour of the air compression assembly on the first projection plane, and the first projection plane is a plane perpendicular to the height direction of the body; the air compression assembly is configured to deliver compressed air to the at least one molecular sieve tank via the intake assembly, the at least one molecular sieve tank is configured to produce oxygen-enriched gas and deliver the oxygen-enriched gas to the oxygen storage assembly, and the oxygen storage assembly is configured to deliver the oxygen-enriched gas outward via the outlet assembly;
an oxygen suction nozzle, arranged on the top face of the body, communicated with the outlet assembly, and configured to contact a nose or mouth to guide oxygen; and
a power supply assembly, arranged on the bottom face of the body, and configured to supply power to the handheld portable oxygen concentrator and serve as a base for the handheld portable oxygen concentrator.

2. The handheld portable oxygen concentrator according to claim 1, wherein each of the top face and the bottom face has a maximum width in a direction perpendicular to the height direction of the body, and a distance between the top face and the bottom face is greater than the maximum width.

3. The handheld portable oxygen concentrator according to claim 2, wherein a perimeter of the projection contour of the body on the first projection plane is less than or equal to 270 mm, to enable single-handed holding.

4. The handheld portable oxygen concentrator according to claim 3, wherein the perimeter of the projection contour of the body on the first projection plane is in a range of 144 mm to 270 mm.

5. The handheld portable oxygen concentrator according to claim 3, wherein a distance between two furthest points of the projection contour of the body on the first projection plane is less than 100 mm.

6. The handheld portable oxygen concentrator according to claim 1, wherein the control board is configured to control an opening/closing of the outlet assembly; the control board is integrated with a button, at least a portion of the button is exposed on the side face of the body;
when the button is triggered, the oxygen-enriched gas in the oxygen storage assembly flows to the oxygen suction nozzle through the outlet assembly.

7. The handheld portable oxygen concentrator according to claim 1, further comprising an upper cover connected to the top face of the body, wherein the oxygen suction nozzle is arranged in a cavity cooperatively formed by the upper cover and the top face;
when the upper cover is opened, the oxygen-enriched gas in the oxygen storage assembly is capable of flowing to the oxygen suction nozzle through the outlet assembly.

8. The handheld portable oxygen concentrator according to claim 7, wherein the control board is configured to control an opening/closing of the outlet assembly;
the handheld portable oxygen concentrator further comprises a sensing unit electrically connected to the control board, the sensing unit is configured to detect and acquire a signal indicating the upper cover being opened from the body or a signal indicating the upper cover being closed on the body;
when the sensing unit detects the signal indicating the upper cover being opened from the body, the oxygen-enriched gas in the oxygen storage assembly flows to the oxygen suction nozzle through the outlet assembly; when the sensing unit detects the signal indicating the upper cover being closed on the body, the oxygen-enriched gas in the oxygen storage assembly is prevented from flowing to the oxygen suction nozzle through the outlet assembly.

9. The handheld portable oxygen concentrator according to claim 1, further comprising a pre-conditioning tank, wherein the pre-conditioning tank communicates the at least one molecular sieve tank and the oxygen storage assembly and is configure to deliver the oxygen-enriched gas produced by the at least one molecular sieve tank to the oxygen storage assembly.

10. The handheld portable oxygen concentrator according to claim 9, wherein the oxygen storage assembly comprises an oxygen storage tank for storing the oxygen-enriched gas, the pre-conditioning tank is arranged in the oxygen storage tank and communicated with the oxygen storage tank.

11. The handheld portable oxygen concentrator according to claim 1, wherein the outlet assembly comprises an upper passage plate, a pulse electromagnetic valve, an oxygen outlet electromagnetic valve, and an equalizing electromagnetic valve, and each of the pulse electromagnetic valve, oxygen outlet electromagnetic valve, and equalizing electromagnetic valve is arranged on the upper passage plate;
the upper passage plate defines a delivery passage and an oxygen outlet passage, the delivery passage communicates the at least one molecular sieve tank and the oxygen storage assembly, and the oxygen outlet passage communicates the oxygen storage assembly and the oxygen suction nozzle;
the pulse electromagnetic valve is communicated with the delivery passage, and is configured to deliver the oxygen-enriched gas produced by the at least one molecular sieve tank to the oxygen storage assembly;
the oxygen outlet electromagnetic valve is communicated with the oxygen outlet passage, and is configured to export the oxygen-enriched gas stored in the oxygen storage assembly to the oxygen suction nozzle;
the number of the at least one molecular sieve tank is more than one, and the equalizing electromagnetic valve communicates the more than one molecular sieve tank.

12. The handheld portable oxygen concentrator according to claim 11, wherein the upper passage plate has a longitudinal axis extending along a thickness direction of the upper passage plate and passing through a center of the upper passage plate, and the pulse electromagnetic valve, the oxygen outlet electromagnetic valve, and the equalizing electromagnetic valve are arranged about the longitudinal axis and are spaced apart from each other.

13. The handheld portable oxygen concentrator according to claim 1, wherein in the height direction of the body, the outlet assembly is arranged above each of the molecular sieve tank and the oxygen storage assembly, and the intake assembly is arranged below the molecular sieve tank.

14. The handheld portable oxygen concentrator according to claim 1, wherein the oxygen suction nozzle comprises a cover body, an oxygen suction portion arranged on the cover body, and an oxygen supply tube arranged on the cover body;
the cover body is arranged on the top face of the body; the oxygen supply tube is arranged in the cover body and communicates the oxygen suction portion and the outlet assembly; the oxygen suction portion is configured to contact the nose or mouth to guide oxygen.

15. The handheld portable oxygen concentrator according to claim 1, wherein the oxygen suction nozzle is any one of a nasal cannula, a breathing mask, a mouthpiece oxygen suction head, a nasal mask oxygen suction head, and a jet-type oxygen supply interface.
